(19) United States
(12) Patent Application Publication
(10) Pub. No.: US 2008/0294694 A1
(43) Pub. Date: Nov. 27, 2008

(54) Method, apparatus, system, medium, and signals for producing interactive video content

(75) Inventors: Babak Maghfourian, Vancouver (CA); Theodore Alexander Curylo, Vancouver (CA); Ying Han, Richmond (CA)

Correspondence Address: Ralph A. Dowell of DOWELL & DOWELL P.C., 2111 Eisenhower Ave, Suite 406, Alexandria, VA, 22314, US

(73) Assignee: VIDEOCLIX TECHNOLOGIES INC., Vancouver (CA)

(21) Appl. No.: 12/153,869

(22) Filed: May 27, 2008

Related U.S. Application Data
(60) Provisional application No. 60/924,659, filed on May 24, 2007.

(51) Int. Cl. G06F 17/30

(52) U.S. Cl. 707/104.1; 707/E17.009

(57) ABSTRACT

A method, apparatus, system and signal for producing interactive video content on a content publisher computer is disclosed. The method involves associating indicia with at least one image portion in the video content, the indicia being operably configured to follow the at least one image portion as a display position of the image portion changes in the video content. The method also involves associating an image portion identifier with the indicia, and associating link properties with the indicia, the link properties being operable to cause transmission of a content location request to a registration server in response to selection of the indicia by a viewer of the interactive video content. The content location request includes the image portion identifier.

### BACKGROUND OF THE INVENTION

1. Field of Invention

This invention relates generally to interactive video.

2. Description of Related Art

Links in HTML documents displayed in web browser applications have been used to lead users to web sites and/or to associated advertising when the link is clicked. Advertisers who sponsor such links may be billed each time the advertisement is viewed, or each time a user clicks on the advertisement to obtain further information.

Web pages including hyperlinks are by nature static, and consequently the link architecture is also static. High speed connections to the internet are becoming increasingly common, and there is a corresponding increase in video and animated content being downloaded and viewed on internet connected computers. Such content may be viewed in QuickTime® or Adobe Flash™ media players for example, which have a large installed base and are generally provided free of charge by the respective software owners.

The use of interactive links in video content has not yet seen the same level of usage as static links in static web pages. Interactive video having object links associated with image portions in the video content is sometimes referred to as “hypervideo” or “hyperlinked video”.

There remains a need for improved methods and apparatus for generating and processing links to image portions in video and animated content.

### SUMMARY OF THE INVENTION

In accordance with one aspect of the invention there is provided a method for producing interactive video content on a content publisher computer. The method involves associating indicia with at least one image portion in the video content, the indicia being operably configured to follow the at least one image portion as a display position of the image portion changes in the video content. The method also involves associating an image portion identifier with the indicia, and associating link properties with the indicia, the link properties being operable to cause transmission of a content location request to a registration server in response to selection of the indicia by a viewer of the interactive video content. The content location request includes the image portion identifier.

The method may involve reading the video content from a video file.

The method may involve generating the image portion identifier.

Generating the image portion identifier may involve generating a universally unique image portion identifier.

The content publication computer may be in communication with the registration server in a computer network, and may further involve transmitting an indicia registration request to the registration server to request registration of the indicia and the associated image portion identifier by the registration server.

Associating the image portion identifier with the indicia may involve transmitting an indicia registration request to the registration server to request registration of the indicia by the registration server, and receiving the image portion identifier from the registration server in response to transmitting the indicia registration request.

Transmitting the indicia registration request may involve transmitting an image portion attribute indicator to the registration server, the image portion attribute indicator indicating at least one attribute of the at least one image portion.

Transmitting the image portion attribute indicator may involve transmitting at least one of a name associated with the at least one image portion, a keyword associated with the at least one image portion, a description associated with the at least one image portion, information identifying occurrences of the at least one image portion in the video content, a duration for which the at least one image portion may be displayed during each the occurrence, and a number of pixels occupied by the at least one image portion during each the occurrence.

Associating the indicia with the at least one image portion may involve displaying the video content in a display area of a video player displayed on the content publisher computer, selecting an image portion of interest in response to user input received from a user of the content publisher computer thereby identifying a selected image portion, and associating the indicia with the selected image portion.

Associating the indicia with the selected image portion may involve associating an indicia shape with the image portion.

The method may involve producing a plurality of frames of video content identifying a position of the indicia shape on the display area in response to user input signals received from a user of the content publisher computer.

The method may involve adding an indicia track to the video content including the plurality of frames identifying the position of the indicia shape, the associated link properties, and the content location request message.

The method may involve writing the interactive video content to a video file.

The method may involve causing the video file to be saved to a persistent storage location on a video server, the video server being in communication with the computer network.

The content publication computer may be in communication with the registration server in a computer network and may further involve transmitting an image portion preview video file to the registration server.

Transmitting the image portion preview video file may involve transmitting an image portion preview video file may involve an identifier identifying the persistent storage location, and information identifying occurrences of the at least one image portion in the interactive video content in the video file.

The content publication computer may be in communication with the registration server in a computer network and may further involve transmitting a video registration request to the registration server to request registration of the interactive video content.

Transmitting the video registration request may involve transmitting a video attribute indicator to the registration server, the video attribute indicator indicating at least one attribute of the interactive video content.

Transmitting the video attribute indicator may involve transmitting at least one of an identifier identifying an originator of the interactive video content, a video identifier associated with the video file, a filename associated with the video file, a duration of the video content, a number of frames per second associated with the video content, a video compression/decompression algorithm (codec) associated with the interactive video content in the video file, an audio compression/decompression algorithm (codec) associated with audio content in the video file, and a video category indicator associated with the video content.

In accordance with another aspect of the invention there is provided an apparatus for producing interactive video content on a content publisher computer. The apparatus includes a processor circuit operably configured to associate indicia with at least one image portion in the video content, the indicia being operably configured to follow the at least one image portion as a display position of the image portion changes in the video content, associate an image portion identifier with the indicia, and associate link properties with the indicia. The link properties are operable to cause transmission of a content location request to a registration server in response to selection of the indicia by a viewer of the interactive video content. The content location request includes the image portion identifier.

The processor circuit may be operably configured to read the video content from a video file.

The processor circuit may be operably configured to generate the image portion identifier.

The processor circuit may be operably configured to generate a universally unique image portion identifier.

The content publication computer may be in communication with the registration server in a computer network, and the processor circuit may be operably configured to transmit an indicia registration request to the registration server to request registration of the indicia and the associated image portion identifier by the registration server.

The processor circuit may be operably configured to associate the image portion identifier with the indicia by transmitting an indicia registration request to the registration server to request registration of the indicia by the registration server, and receiving the image portion identifier from the registration server in response to transmitting the indicia registration request.

The processor circuit may be operably configured to transmitting the indicia registration request by transmitting an image portion attribute indicator to the registration server, the image portion attribute indicator indicating at least one attribute of the at least one image portion.

The processor circuit may be operably configured to transmitting the image portion attribute indicator by transmitting at least one of a name associated with the at least one image portion, a keyword associated with the at least one image portion, a description associated with the at least one image portion, information identifying occurrences of the at least one image portion in the video content, a duration for which the at least one image portion may be displayed during each the occurrence, and a number of pixels occupied by the at least one image portion during each the occurrence.

The processor circuit may be operably configured to associate the indicia with the at least one image portion by displaying the video content in a display area of a video player displayed on the content publisher computer, selecting an image portion of interest in response to user input received from a user of the content publisher computer thereby identifying a selected image portion, and associating the indicia with the selected image portion.

The processor circuit may be operably configured to associate the indicia with the selected image portion by associating an indicia shape with the image portion.

The processor circuit may be operably configured to produce a plurality of frames of video content identifying a position of the indicia shape on the display area in response to user input signals received from a user of the content publisher computer.

The processor circuit may be operably configured to add an indicia track to the video content including the plurality of frames identifying the position of the indicia shape, the associated link properties, and the content location request message.

The processor circuit may be operably configured to write the interactive video content to a video file.

The processor circuit may be operably configured to cause the video file to be saved to a persistent storage location on a video server, the video server being in communication with the computer network.

The content publication computer may be in communication with the registration server in a computer network and the processor circuit may be operably configured to transmit an image portion preview video file to the registration server.

The processor circuit may be operably configured to transmit an image portion preview video file may include an identifier identifying the persistent storage location, and information identifying occurrences of the at least one image portion in the interactive video content in the video file.

The content publication computer may be in communication with the registration server in a computer network and the processor circuit may be operably configured to transmit a video registration request to the registration server to request registration of the interactive video content.

The processor circuit may be operably configured to transmit the video registration request by transmitting a video attribute indicator to the registration server, the video attribute indicator indicating at least one attribute of the interactive video content.

The processor circuit may be operably configured to transmitting the video attribute indicator by transmitting at least one of an identifier identifying an originator of the interactive video content, a video identifier associated with the video file, a filename associated with the video file, a duration of the video content, a number of frames per second associated with the video content, a video compression/decompression algorithm (codec) associated with the interactive video content in the video file, an audio compression/decompression algorithm (codec) associated with audio content in the video file, and a video category indicator associated with the video content.

In accordance with another aspect of the invention there is provided a computer readable medium encoded with codes for directing a processor circuit to produce interactive video content on a content publisher computer. The codes direct the processor circuit to associate indicia with at least one image portion in the video content, the indicia being operably configured to follow the at least one image portion as a display position of the image portion changes in the video content. The codes also direct the processor circuit to associate an image portion identifier with the indicia, and associate link properties with the indicia. The link properties are operable to cause transmission of a content location request to a registration server in response to selection of the indicia by a viewer of the interactive video content. The content location request includes the image portion identifier.

In accordance with another aspect of the invention there is provided a computer readable signal encoded with codes for directing a processor circuit to produce interactive video content on a content publisher computer. The codes direct the processor circuit to associate indicia with at least one image portion in the video content, the indicia being operably configured to follow the at least one image portion as a display position of the image portion changes in the video content. The codes also direct the processor circuit to associate an image portion identifier with the indicia, and associate link properties with the indicia. The link properties are operable to cause transmission of a content location request to a registration server in response to selection of the indicia by a viewer of the interactive video content. The content location request includes the image portion identifier.

In accordance with another aspect of the invention there is provided a method for registering indicia associated with an image portion of interest on a registration server in communication with a computer network, the image portion occurring in interactive video content produced on a content publisher computer. The method involves receiving an indicia registration request from the content publisher computer, causing an image portion record to be produced in response to receiving the indicia registration request. The method also involves associating the image portion record with an image portion identifier, and causing the image portion record to be stored in a database.

Receiving the indicia registration request may involve receiving the image portion identifier from the content publisher computer.

The method may involve generating the image portion identifier and transmitting the image portion identifier to the content publisher computer in response to receiving the indicia registration request.

Generating the image portion identifier may involve generating a universally unique image portion identifier.

Receiving the indicia registration request may involve receiving an image portion attribute indicator from the content publisher computer and causing the image portion record to be produced may involve causing the image portion attribute indicator to be saved in an image portion attribute indicator field in the image portion record.

Receiving the image portion attribute indicator may involve receiving at least one of information identifying occurrences of the image portion in the video content, a duration for which the image portion may be displayed during each the occurrence, and a number of pixels occupied by the image portion during each the occurrence.

Associating the image portion record with the image portion identifier may involve causing the image portion identifier to be stored in an image portion identifier field in the image portion record.

The method may involve receiving an image portion preview video file from the content publisher computer, and causing the image portion record to be produced may involve causing the image portion preview video file to be saved in an image portion preview field in the image portion record.

Receiving the image portion preview video file may involve receiving an image portion preview video file may involve an identifier identifying a location of the interactive video content on the computer network, and information identifying occurrences of the image portion in the interactive video content.

The method may involve receiving a video registration request from the content publisher computer, causing a video record to be produced in response to receiving the video registration request, associating the video record with a video identifier, and causing the video record to be stored in the database.

Receiving the video registration request may involve receiving a video attribute indicator from the content publisher computer, the video attribute indicator indicating at least one attribute of the interactive video content, and may further involve causing the video attribute indicator to be stored in a video attribute indicator field in the video record.

Receiving the video attribute indicator may involve receiving one of an identifier identifying an originator of the interactive video content, a filename associated with the video file, a duration of the interactive video content, a number of frames per second associated with the interactive video content, a video compression/decompression algorithm (codec) associated with the interactive video content in the video file, and an audio compression/decompression algorithm (codec) associated with audio content in the video file, and a video category indicator associated with the interactive video content.

Associating the video record with the video identifier may involve causing the video identifier to be saved in a video identifier field in the video record.

The method may involve associating the image portion record with the video record in the database.

Associating the image portion record with the video record may involve causing the video identifier to be stored in a video identifier field in the image portion record.

In accordance with another aspect of the invention there is provided an apparatus for registering indicia associated with an image portion of interest on a registration server in communication with a computer network, the image portion occurring in interactive video content produced on a content publisher computer. The apparatus includes a processor circuit operably configured to receive an indicia registration request from the content publisher computer, cause an image portion record to be produced in response to receiving the indicia registration request, associate the image portion record with an image portion identifier, and cause the image portion record to be stored in a database.

The processor circuit may be operably configured to receive the image portion identifier from the content publisher computer.

The processor circuit may be operably configured to generate the image portion identifier and to transmit the image portion identifier to the content publisher computer in response to receiving the indicia registration request.

The processor circuit may be operably configured to generate a universally unique image portion identifier.

The processor circuit may be operably configured to receive the indicia registration request by receiving an image portion attribute indicator from the content publisher computer and the processor circuit may be operably configured to cause the image portion record to be produced by causing the image portion attribute indicator to be saved in an image portion attribute indicator field in the image portion record.

The processor circuit may be operably configured to receive the image portion attribute indicator by receiving at least one of information identifying occurrences of the image portion in the video content, a duration for which the image portion may be displayed during each the occurrence, and a number of pixels occupied by the image portion during each the occurrence.

The processor circuit may be operably configured to associate the image portion record with the image portion identifier by causing the image portion identifier to be stored in an image portion identifier field in the image portion record.

The processor circuit may be operably configured to receive an image portion preview video file from the content publisher computer, and cause the image portion preview video file to be saved in an image portion preview field in the image portion record.

The processor circuit may be operably configured to receive an image portion preview video file may include an identifier identifying a location of the interactive video content on the computer network, and information identifying occurrences of the image portion in the interactive video content.

The processor circuit may be operably configured to receive a video registration request from the content publisher computer, cause a video record to be produced in response to receiving the video registration request, associate the video record with a video identifier, and cause the video record to be stored in the database.

The processor circuit may be operably configured to receive the video registration request by receiving a video attribute indicator from the content publisher computer, the video attribute indicator indicating at least one attribute of the interactive video content, and the processor circuit may be operably configured to cause the video attribute indicator to be stored in a video attribute indicator field in the video record.

The processor circuit may be operably configured to receive the video attribute indicator by receiving one of an identifier identifying an originator of the interactive video content, a filename associated with the video file, a duration of the interactive video content, a number of frames per second associated with the interactive video content, a video compression/decompression algorithm (codec) associated with the interactive video content in the video file, and an audio compression/decompression algorithm (codec) associated with audio content in the video file, and a video category indicator associated with the interactive video content.

The processor circuit may be operably configured to associate the video record with the video identifier by causing the video identifier to be saved in a video identifier field in the video record.

The processor circuit may be operably configured to associate the image portion record with the video record in the database.

The processor circuit may be operably configured to associate the image portion record with the video record by causing the video identifier to be stored in a video identifier field in the image portion record.

In accordance with another aspect of the invention there is provided a computer readable medium encoded with codes for directing a processor circuit to register indicia associated with an image portion of interest on a registration server in communication with a computer network, the image portion occurring in interactive video content produced on a content publisher computer. The codes direct the processor circuit to receive an indicia registration request from the content publisher computer, cause an image portion record to be produced in response to receiving the indicia registration request, associate the image portion record with an image portion identifier, and cause the image portion record to be stored in a database.

In accordance with another aspect of the invention there is provided a computer readable signal encoded with codes for directing a processor circuit to register indicia associated with an image portion of interest on a registration server in communication with a computer network, the image portion occurring in interactive video content produced on a content publisher computer. The codes direct the processor circuit to receive an indicia registration request from the content publisher computer, cause an image portion record to be produced in response to receiving the indicia registration request, associate the image portion record with an image portion identifier, and cause the image portion record to be stored in a database.

In accordance with another aspect of the invention there is provided a method for associating a sponsor content location with an image portion of interest occurring in interactive video content, the image portion having been registered on a registration server in communication with a computer network. The method involves receiving a offer message from a sponsor computer at the registration server, the offer message including an image portion identifier identifying the image portion and a sponsor content location identifier. The method also involves causing an image portion record associated with the image portion identifier to be located in a database in communication with the registration server, and associating the sponsor content location identifier with the image portion record.

Associating the sponsor content location identifier with the image portion record may involve storing the sponsor content location identifier in a sponsor content location field in the image portion record.

Associating the sponsor content location identifier with the image portion record may involve causing a content location record to be produced in response to receiving the offer message, causing the sponsor content location provided in the offer message to be stored in a content location field in the content location record, associating the content location record with the image portion record, and causing the content location record to be stored in the database.

Associating the content location record with the image portion record may involve storing the image portion identifier in an image portion identifier field in the content location record.

Receiving the offer message may involve receiving at least one offer restriction, the at least one offer restriction may involve at least one of a cost-per-click offer, a budget associated with the cost-per-click offer, a geographic indicator indicating a targeted geographic region, a video category, a start time associated with the cost-per-click offer, and an end time associated with the cost-per-click offer, and and causing the content location record to be produced may involve storing the at least one offer restriction in an offer restriction field in the content location record.

The method may involve causing a plurality of image portion records to be located in the database, transmitting a web page to the sponsor computer, the web page including an identifier identifying each of the image portions associated with respective image portion records in the plurality of image portion records, and transmitting an image portion preview video file to the sponsor computer for each respective image portion.

Transmitting the image portion preview video file may involve transmitting an image portion preview video file may involve an identifier identifying a location of the interactive video content on the computer network, and information identifying occurrences of the image portion in the interactive video content.

In accordance with another aspect of the invention there is provided an apparatus for associating a sponsor content location with an image portion of interest occurring in interactive video content, the image portion having been registered on a registration server in communication with a computer network. The apparatus includes a processor circuit operably configured to receive a offer message from a sponsor computer at the registration server, the offer message including an image portion identifier identifying the image portion and a sponsor content location identifier. The processor circuit is also operably configured to cause an image portion record associated with the image portion identifier to be located in a database in communication with the registration server, and to associate the sponsor content location identifier with the image portion record.

The processor circuit may be operably configured to associate the sponsor content location identifier with the image portion record by storing the sponsor content location identifier in a sponsor content location field in the image portion record.

The processor circuit may be operably configured to associate the sponsor content location identifier with the image portion record by causing a content location record to be produced in response to receiving the offer message, causing the sponsor content location provided in the offer message to be stored in a content location field in the content location record, associating the content location record with the image portion record, and causing the content location record to be stored in the database.

The processor circuit may be operably configured to associate the content location record with the image portion record by storing the image portion identifier in an image portion identifier field in the content location record.

The processor circuit may be operably configured to receive at least one offer restriction, the at least one offer restriction may include at least one of a cost-per-click offer, a budget associated with the cost-per-click offer, a geographic indicator indicating a targeted geographic region, a video category, a start time associated with the cost-per-click offer, and an end time associated with the cost-per-click offer, and and the processor circuit may be operably configured to cause the content location record to be produced by storing the at least one offer restriction in an offer restriction field in the content location record.

The processor circuit may be operably configured to cause a plurality of image portion records to be located in the database, transmit a web page to the sponsor computer, the web page including an identifier identifying each of the image portions associated with respective image portion records in the plurality of image portion records, and transmit an image portion preview video file to the sponsor computer for each respective image portion.

The processor circuit may be operably configured to transmit an image portion preview video file may include an identifier identifying a location of the interactive video content on the computer network, and information identifying occurrences of the image portion in the interactive video content.

In accordance with another aspect of the invention there is provided a computer readable medium encoded with codes for directing a processor circuit associate a sponsor content location with an image portion of interest occurring in interactive video content, the image portion having been registered on a registration server in communication with a computer network. The codes direct the processor circuit to receive a offer message from a sponsor computer at the registration server, the offer message including an image portion identifier identifying the image portion and a sponsor content location identifier. The codes also direct the processor circuit to cause an image portion record associated with the image portion identifier to be located in a database in communication with the registration server, and to associate the sponsor content location identifier with the image portion record.

In accordance with another aspect of the invention there is provided a computer readable signal encoded with codes for directing a processor circuit associate a sponsor content location with an image portion of interest occurring in interactive video content, the image portion having been registered on a registration server in communication with a computer network. The codes direct the processor circuit to receive a offer message from a sponsor computer at the registration server, the offer message including an image portion identifier identifying the image portion and a sponsor content location identifier. The codes also direct the processor circuit to cause an image portion record associated with the image portion identifier to be located in a database in communication with the registration server, and to associate the sponsor content location identifier with the image portion record.

In accordance with another aspect of the invention there is provided a method for providing a content location to a client display device in communication with a registration server in a computer network. The method involves receiving a content location request message from the client display device at the registration server, the content location request message including an image portion identifier identifying a image portion displayed in interactive video content on the client display device. The method also involves determining a current content location associated with the image portion identifier, producing a content location message including a content location identifier identifying the current content location, and transmitting the content location message to the client display device.

Determining the current content location may involve causing a plurality of content location records associated with the image portion identifier to be located in a database, each content location record representing an offer from a sponsor computer to sponsor the image portion, determining which one of the plurality of content location records represents a successful offer, and reading a content location identifier from a content location identifier field in the one of the plurality of content location records representing the successful offer.

The method may involve determining a geographic region associated with the content location request message and determining which one of the plurality of content location records represents the successful offer may involve determining which of the content location records includes a geographic indicator that matches the geographic region associated with the content location request message, the geographic indicator being stored in a geographic indicator field in the content location record.

Determining which one of the plurality of content location records represents the successful offer may involve determining which of the content location records meets a criterion.

Determining which of the content location records meets the criterion, may involve determining, for each content location record, whether at least one of a budget value stored in a budget value field in the content location record has not yet been reached, a video category indicator stored in a video category indicator field in the content location record matches a video category indicator associated with the interactive video content in which the image portion occurs, a start time stored in a start time field in the content location record has passed, and an end time stored in an end time field in the content location record has not yet passed.

Determining which one of the plurality of content location records represents the successful offer may involve determining which of the content location records that meet the criterion has a greatest cost-per-click (CPC) offer value stored in a cost-per-click-field in the content location record.

In accordance with another aspect of the invention there is provided an apparatus for providing a content location to a client display device in communication with a registration server in a computer network. The apparatus includes a processor circuit operably configured to receive a content location request message from the client display device at the registration server, the content location request message including an image portion identifier identifying a image portion displayed in interactive video content on the client display device. The processor circuit is also operably configured to determine a current content location associated with the image portion identifier, produce a content location message including a content location identifier identifying the current content location, and to transmit the content location message to the client display device.

The processor circuit may be operably configured to determine the current content location by causing a plurality of content location records associated with the image portion identifier to be located in a database, each content location record representing an offer from a sponsor computer to sponsor the image portion, determining which one of the plurality of content location records represents a successful offer, and reading a content location identifier from a content location identifier field in the one of the plurality of content location records representing the successful offer.

The processor circuit may be operably configured to determine a geographic region associated with the content location request message and the processor circuit may be operably configured to determine which one of the plurality of content location records represents the successful offer by determining which of the content location records includes a geographic indicator that matches the geographic region associated with the content location request message, the geographic indicator being stored in a geographic indicator field in the content location record.

The processor circuit may be operably configured to determine which one of the plurality of content location records represents the successful offer by determining which of the content location records meets a criterion.

The processor circuit may be operably configured to determine which of the content location records meets the criterion by determining, for each content location record, whether at least one of a budget value stored in a budget value field in the content location record has not yet been reached, a video category indicator stored in a video category indicator field in the content location record matches a video category indicator associated with the interactive video content in which the image portion occurs, a start time stored in a start time field in the content location record has passed, and an end time stored in an end time field in the content location record has not yet passed.

The processor circuit may be operably configured to determine which one of the plurality of content location records represents the successful offer by determining which of the content location records that meet the criterion has a greatest cost-per-click (CPC) offer value stored in a cost-per-click-field in the content location record.

In accordance with another aspect of the invention there is provided a computer readable medium encoded with codes for directing a processor circuit to provide a content location to a client display device in communication with a registration server in a computer network. The codes direct the processor circuit to receive a content location request message from the client display device at the registration server, the content location request message including an image portion identifier identifying a image portion displayed in interactive video content on the client display device. The codes also direct the processor circuit to determine a current content location associated with the image portion identifier, produce a content location message including a content location identifier identifying the current content location, and transmit the content location message to the client display device.

In accordance with another aspect of the invention there is provided a computer readable signal encoded with codes for directing a processor circuit to provide a content location to a client display device in communication with a registration server in a computer network. The codes direct the processor circuit to receive a content location request message from the client display device at the registration server, the content location request message including an image portion identifier identifying a image portion displayed in interactive video content on the client display device. The codes also direct the processor circuit to determine a current content location associated with the image portion identifier, produce a content location message including a content location identifier identifying the current content location, and transmit the content location message to the client display device.

In accordance with another aspect of the invention there is provided a method for displaying interactive video content on a client display device, the client display device being in communication with a registration server in a computer network. The method involves causing the interactive video to be displayed on the client display device, the interactive video including at least one image portion having an associated indicia, the indicia being operably configured to follow the image portion as a display position of the image portion changes in the video content, and transmitting a content location request message to the registration server in response to a user of the client display device selecting the indicia. The content location request message includes an image portion identifier identifying the image portion.

The method may involve receiving a content location message from the registration server, the content location message including a content location identifier identifying a current content location associated with the image portion, and causing content associated with the content location identifier to be displayed on the client display device.

Causing the content to be displayed may involve causing one of causing content associated with the content location identifier to be displayed in an internet browser window on the client display device, causing content associated with the content location identifier to be displayed in a portion of a video viewer application window on the client display device, and causing a link to the content location to be displayed in a the video viewer application window on the client display device.

In accordance with another aspect of the invention there is provided an apparatus for displaying interactive video content on a client display device, the client display device being in communication with a registration server in a computer network. The apparatus includes a processor circuit operably configured to cause the interactive video to be displayed on the client display device, the interactive video including at least one image portion having an associated indicia, the indicia being operably configured to follow the image portion as a display position of the image portion changes in the video content, and transmit a content location request message to the registration server in response to a user of the client display device selecting the indicia. The content location request message includes an image portion identifier identifying the image portion.

The processor circuit may be operably configured to receive a content location message from the registration server, the content location message including a content location identifier identifying a current content location associated with the image portion, and cause content associated with the content location identifier to be displayed on the client display device.

The processor circuit may be operably configured to cause one of cause content associated with the content location identifier to be displayed in an internet browser window on the client display device, cause content associated with the content location identifier to be displayed in a portion of a video viewer application window on the client display device, and cause a link to the content location to be displayed in a the video viewer application window on the client display device.

In accordance with another aspect of the invention there is provided a computer readable medium encoded with codes for directing a processor circuit to display interactive video content on a client display device, the client display device being in communication with a registration server in a computer network. The codes direct the processor circuit to cause the interactive video to be displayed on the client display device, the interactive video including at least one image portion having an associated indicia, the indicia being operably configured to follow the image portion as a display position of the image portion changes in the video content. The codes also direct the processor circuit to transmit a content location request message to the registration server in response to a user of the client display device selecting the indicia, the content location request message including an image portion identifier identifying the image portion.

In accordance with another aspect of the invention there is provided a computer readable signal encoded with codes for directing a processor circuit to display interactive video content on a client display device, the client display device being in communication with a registration server in a computer network. The codes direct the processor circuit to cause the interactive video to be displayed on the client display device, the interactive video including at least one image portion having an associated indicia, the indicia being operably configured to follow the image portion as a display position of the image portion changes in the video content. The codes also direct the processor circuit to transmit a content location request message to the registration server in response to a user of the client display device selecting the indicia, the content location request message including an image portion identifier identifying the image portion.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a system for producing interactive video content in accordance with a first embodiment of the invention;

FIG. 2 is a schematic representation of a content publisher computer used in the system shown in FIG. 1;

FIG. 3 is a flowchart of a process executed by the content publisher computer shown in FIG. 2 for loading video content;

FIG. 4 is a screenshot of a content production screen displayed by the content publisher computer shown in FIG. 2;

FIG. 5 is a flowchart of one embodiment video content production process executed by the content publisher computer shown in FIG. 2;

FIG. 6 is a flowchart of a process executed by the content publisher computer shown in FIG. 2 for associating indicia with the image portion;

FIG. 7 is a tabular representation of a set of indicia variables produced by the content publisher computer shown in FIG. 2;

FIG. 8 is a tabular representation of an exemplary populated set of the indicia variables shown in FIG. 7;

FIG. 9 is a flowchart of a process executed by the content publisher computer shown in FIG. 2 for associating an identifier with the indicia;

FIG. 10 is a representation of an exemplary indicia registration request produced by the content publisher computer shown in FIG. 2;

FIG. 11 is a flowchart of an alternative process executed by the content publisher computer shown in FIG. 2 for associating the identifier with the indicia;

FIG. 12 is a representation of an exemplary indicia registration request produced by the content publisher computer shown in FIG. 2 in the alternative process shown in FIG. 11;

FIG. 13 is a flowchart of a process executed by the content publisher computer shown in FIG. 2 for associating link properties with the indicia;

FIG. 14 is a schematic representation of a QuickTime video file produced by the content publisher computer shown in FIG. 2;

FIG. 15 is a flowchart of an alternative process executed by the content publisher computer shown in FIG. 2 for producing interactive video content;

FIG. 16 is an exemplary format of a video registration request produced by the content publisher computer shown in FIG. 2;

FIG. 17 is a schematic representation of an image portion preview file in QuickTime format produced by the content publisher computer shown in FIG. 2;

FIG. 18 is a schematic representation of a processor circuit for implementing a registration server shown in FIG. 1;

FIG. 19 is a schematic representation of a processor circuit for implementing a database shown in FIG. 1;

FIG. 20 is a flowchart of a process for registering a new interactive video file executed by the registration server shown in FIG. 19;

FIG. 21 is a tabular representation of a video record stored in the database shown in FIG. 19;

FIG. 22 is a flowchart of a process executed by the registration server processor circuit shown in FIG. 18 for registering an image portion;

FIG. 23 is a tabular representation of an image portion record stored in the database shown in FIG. 19;

FIG. 24 is a flowchart of a process for registering the image portion in accordance with an alternative embodiment of the invention;

FIG. 25 is a schematic representation of a generic processor circuit for implementing a sponsor computer and/or a client display device shown in FIG. 1;

FIG. 26 is a screenshot of an exemplary sponsor search page transmitted by the registration server processor circuit shown in FIG. 18 to the sponsor computer processor circuit shown in FIG. 25;

FIG. 27 is a flowchart of a process executed by the registration server shown in FIG. 18 for processing the sponsor search request from the sponsor computer shown in FIG. 25;

FIG. 28 is an exemplary screenshot of a sponsor web page transmitted by the registration server processor circuit shown in FIG. 18 to the sponsor computer processor circuit shown in FIG. 25;

FIG. 29 is an exemplary offer message produced by the sponsor computer shown in FIG. 25;

FIG. 30 is a flowchart of a process executed by the registration server shown in FIG. 18 for processing the offer message shown in FIG. 29;

FIG. 31 is a tabular representation of a content location record stored in the database shown in FIG. 19;

FIG. 32 is a flowchart of a process executed by the client display device shown in FIG. 25 for playing interactive video content received from a video server shown in FIG. 1;

FIG. 33 is a screenshot of an exemplary video player window displayed in a web browser window on the client display device shown in FIG. 25;

FIG. 34 is a flowchart of a process executed by the client display device shown in FIG. 25 for producing a content location request;

FIG. 35 is a flowchart of a process executed by registration server shown in FIG. 18 for producing a content location response to the content location request shown in FIG. 34;

FIG. 36 is a flowchart of a process executed by registration server shown in FIG. 18 for locating a successful content location record stored on the database shown in FIG. 19;

FIG. 37 is an exemplary HTTP content location response produced by the registration server shown in FIG. 18; and

FIG. 38 is a flowchart of a process executed by the client display apparatus shown in FIG. 25 for handling the content location response shown in FIG. 36.

### DETAILED DESCRIPTION

System Overview

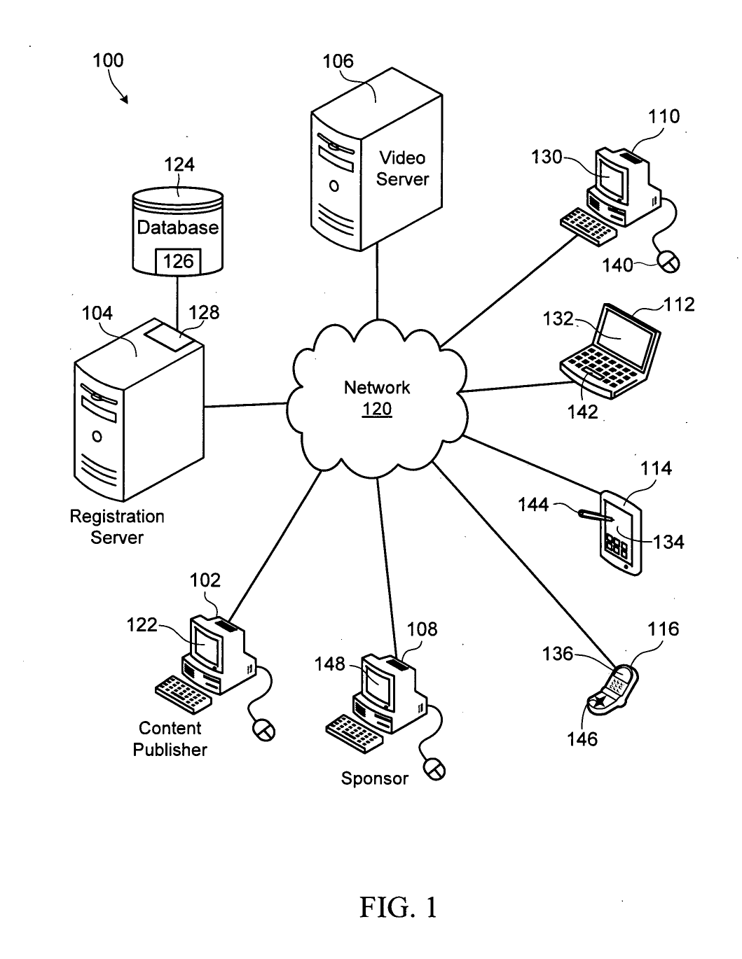

Referring to FIG. 1, a system for producing interactive video content is shown generally at 100. The system 100 includes a content publisher computer 102, a registration server 104, a video server 106, a sponsor computer 108, and a plurality of client display devices 110, 112, 114 and 116, all of which are in a communication with a computer network 120.

The content publisher computer 102 includes a display 122 for displaying video content and is operably configured to transform video content into interactive video content. The video content may be provided in a digital video file format such as Apple QuickTime, or Adobe Flash, and generally includes sequential still images that include at least some image portions that change display position and/or shape in the sequential still images. The image portions may include animated objects, representations of real objects, or a combination of a still image background and real and/or animated foreground image portions.

The system 100 further includes a database 124, which is in communication with the registration server 104. In the embodiment shown in FIG. 1, the database 124 is implemented on a separate computer platform and includes a database management system 126 for managing the database and for interfacing with the registration server 104. The registration server 104 also includes a database interface 128 for interfacing with the database 124 through the database management system 126.

Alternatively, in other embodiments the database 124 may be hosted on the registration server 104 as a separate database process on the server.

The video server 106 includes persistent storage such as a hard drive (not shown), for storing interactive video content produced by the content publisher computer 102. The video server 106 is also operable to transmit interactive video content to the client display devices 110, 112, 114, and 116. In one embodiment the video server 106 includes a hyper text transfer protocol (HTTP) server (not shown) for receiving video content requests, and a real time streaming protocol (RTSP) server (not shown) or a real time messaging protocol (RTMP) server (also not shown) for streaming the requested video content to one of the client display devices 110, 112, 114, or 116.

The sponsor computer 108 is in communication with the registration server 104 for viewing image portions that are available for sponsorship, as described later herein. The sponsor computer 108 includes a display 148 for displaying video content and/or web pages, such as may be received during operation of the system 100.

In this embodiment, the client display device 110 is a conventional desktop computer, the client display device 112 is a laptop computer, the client display device 114 is a handheld tablet computer, and the client display device 116 is a cellular telephone. Each of the client display devices 110, 112, 114, and 116 has a respective display 130, 132, 134, and 136 for displaying video content received from the video server 106.

Each of the client display devices 110, 112, 114, and 116 also has a pointing device 140, 142, 144, and 146. In this embodiment the pointing device 140 is a conventional handheld pointing device such as a computer mouse, the pointing device 142 is a touch pad, the pointing device 144 is a stylus for drawing on a touch sensitive display 134, and the pointing device 146 is a pointer actuator button. The pointing devices 140, 142, 144, and 146 facilitate movement of a pointer displayed on a display area of the respective displays 130, 132, 134, and 136 in response to user movements of the pointing device and further facilitate selection of image portions in the interactive video content in response to user actuation of actuator buttons (not shown) associated with the pointing device.

Content Publisher Computer

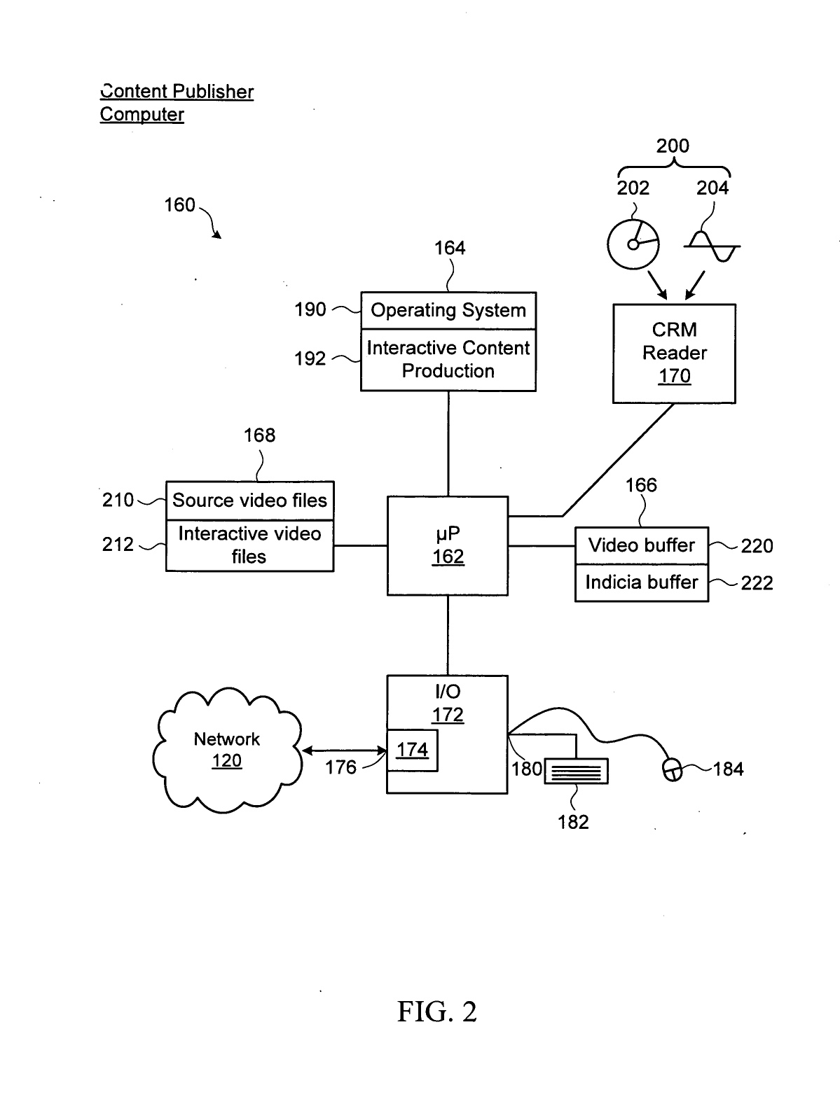

Referring to FIG. 2, a processor circuit for implementing the content publisher computer 102 is shown generally at 160. The content publisher computer processor circuit 160 includes a microprocessor 162, a program memory 164, a random access memory (RAM) 166, a hard drive 168, a computer readable medium (CRM) reader 170, and an input/output port (I/O) 172, all of which are in communication with the microprocessor 162.

The I/O port 172 includes an interface 174, such as a network interface card having an input/output 176 in communication with the network 120. The interface 174 facilitates transmitting messages to the registration server 104 and receiving messages from the registration server.

The I/O port 172 further includes an input 180 for receiving user input signals from a character input device 182, such as a keyboard, and from a pointing device 184, such as a computer mouse.

Program codes for directing the microprocessor 162 to effect interactive video content production functions, are stored in the program memory 164, which may be implemented as a random access memory (RAM), and/or a hard disk drive (HDD), or a combination thereof. The program memory 164 includes a block of codes 190 for directing the processor circuit to effect operating system (O/S) functions, such as handling user input signals produced by the character input device 182 and/or pointing device 184. The program memory 164 also includes a block of codes 192 for directing the processor circuit to provide interactive video content production functions.

The CRM reader 170 may be used to load user interface program codes from a computer readable medium 200 into the program memory 164. The computer readable medium 200 may be a CD ROM disk 202. Alternatively the program codes may be provided by a computer readable signal 204, which may be received over a network such as the internet, for example.

The hard drive 168 includes a source video file store 210 for storing video content that is to be used as a source for production of the interactive video content. The hard drive 168 further includes a store 212 for storing interactive video files produced by the content publisher computer 102.

The RAM 166 includes a video buffer 220 for temporary storage of video content in the RAM. The RAM 166 further includes a buffer 222 for temporary storage of indicia data.

Interactive Content Production

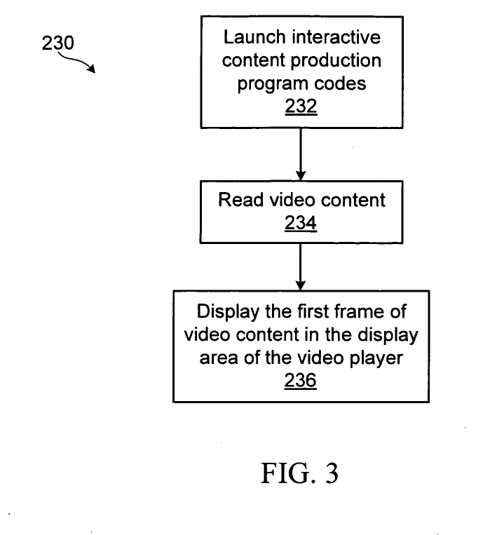

Referring to FIG. 3, a process flowchart including blocks of code for directing the processor circuit 160 of the content publisher computer 102 to load video content to which interactive functions are to be added is shown generally at 230. The blocks generally represent codes that may be read from the CD ROM disk 202 or the computer readable signal 204, and stored in the program memory 164, for directing the microprocessor 162 to perform various functions related to the process 230. The actual code to implement each block may be written in any suitable program language, such as C, C++, and/or assembly code, for example.

The process begins at block 232 which directs the microprocessor 162 to launch the interactive content production program codes 192. In one embodiment the interactive content production application may be the VideoClix™ interactive content authoring software available from VideoClix Inc. of Vancouver, Canada. The use of the VideoClix software to produce interactive video content is described in more detail in the VideoClix user manual version 3.0, which is incorporated herein by reference.

The program codes 192 direct the microprocessor 162 to cause a content production screen to be displayed on the display 122 of the content publication computer 102.

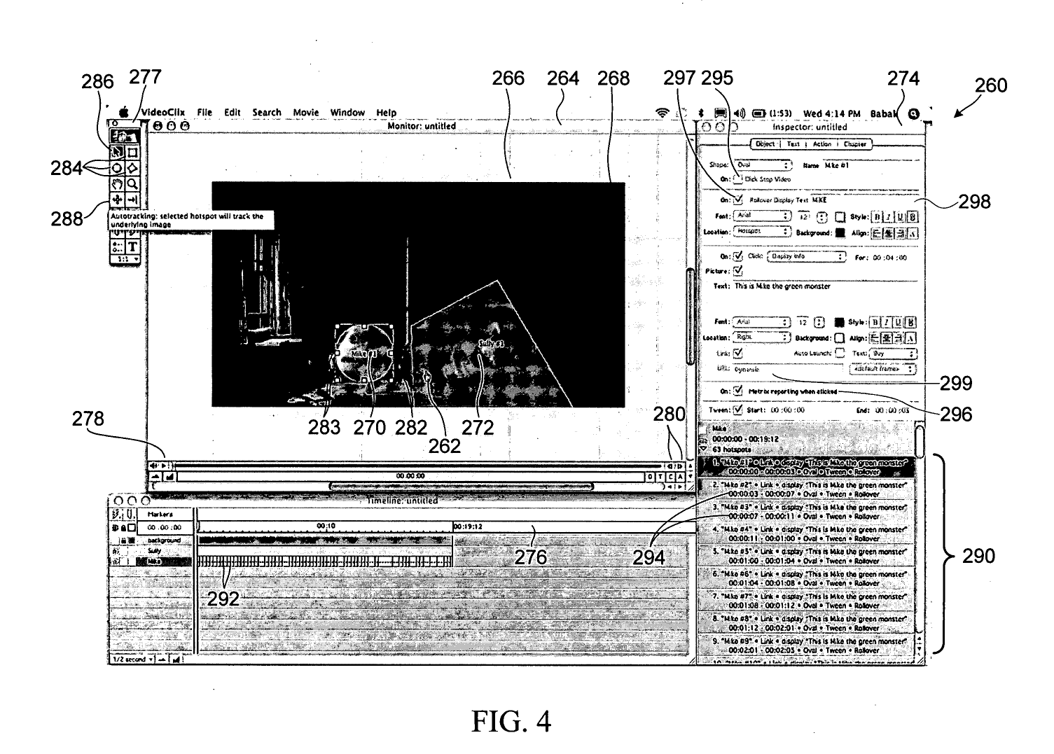

Referring to FIG. 4, a screenshot of the content production screen is shown generally at 260. The content production screen 260 includes a video player window 264 having a display area 266 for displaying video content. The video player window 264 further includes playback controls including a play button 278 and chapter buttons 280, for example.

The content production screen 260 also includes an image portion inspector window 274 for displaying attributes associated with a selected image portion, a timeline window 276 that provides a timeline display of frames associated with a selected image portion, and a toolbar 277. The toolbar 277 includes a plurality of function invocation buttons, including indicia shape buttons 284 for invoking an indicia shape function, a selector tool button 286 for invoking a selector function for moving the indicia shape, and a real time tracking button 288 for invoking a tracking function that causes the indicia shape to move in response to movements of the pointing device 184. The content production screen 260 also displays a pointer 262 having a coordinate location that changes in response to user input from the pointing device 184.

Referring back to FIG. 3, the process 230 continues at block 234, which directs the microprocessor 162 to read video content. In this embodiment, the video content is read from the source video file store 210 on the hard drive 168. In other embodiments the video content may be read directly from persistent storage on the video server 106. In general the video content is represented by a plurality of sequential frames, each frame including data representing a still image. In this embodiment a first plurality of frames of video content are initially loaded from the source video file store 210 into the video buffer 220 in the RAM 166. Block 236 then directs the microprocessor 162 to read a first frame of the video content from the video buffer 220 and to display the first frame in the video player window 264.

Referring back to FIG. 4, the video content is displayed in the display area 266 of the video player window 264. In this embodiment the video content includes a background scene 268, and first and second image portions 270 and 272. The image portions 270 and 272 change display position in sequential frames of the video content when the video content is played in response to a user selecting the play button 278. Subsequent selection of the play button 278 while the video content is playing causes the video content to be paused such that only a single frame is displayed (as shown in FIG. 3). The chapter buttons 280, when selected, facilitate repositioning the playback point to pre-defined chapter points in the video content. The user of the content production computer 102 is thus able to position the playback point in the video content to a desired frame, which for example may be a first frame displaying the image portions 270 and 272.

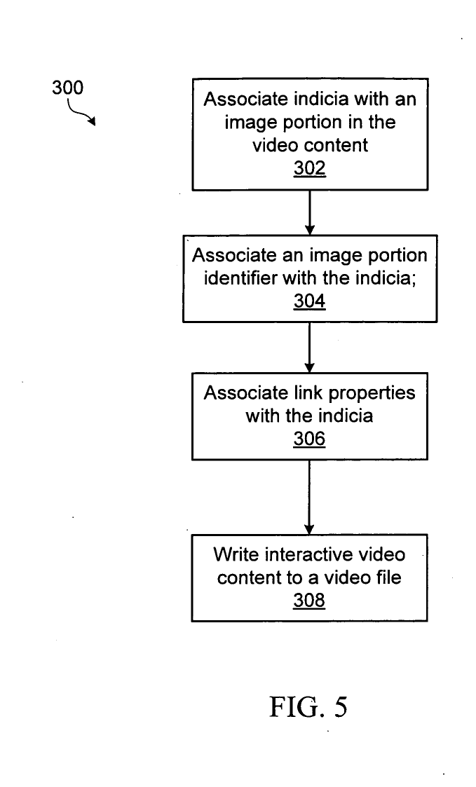

Referring to FIG. 5 a process flowchart including blocks of code for directing the processor circuit 160 to produce interactive video content is shown generally at 300.

The process 300 generally involves associating indicia with at least one image portion in the video content. The indicia are operably configured to follow the image portion (such as the image portion 270 shown in FIG. 4) as a display position of the image portion changes in the video content. An image portion identifier is associated with the indicia and link properties are also associated with the indicia. The link properties are operable to cause transmission of a content location request to the registration server in response to selection of the indicia by a viewer of the interactive video content. The content location request includes the image portion identifier.

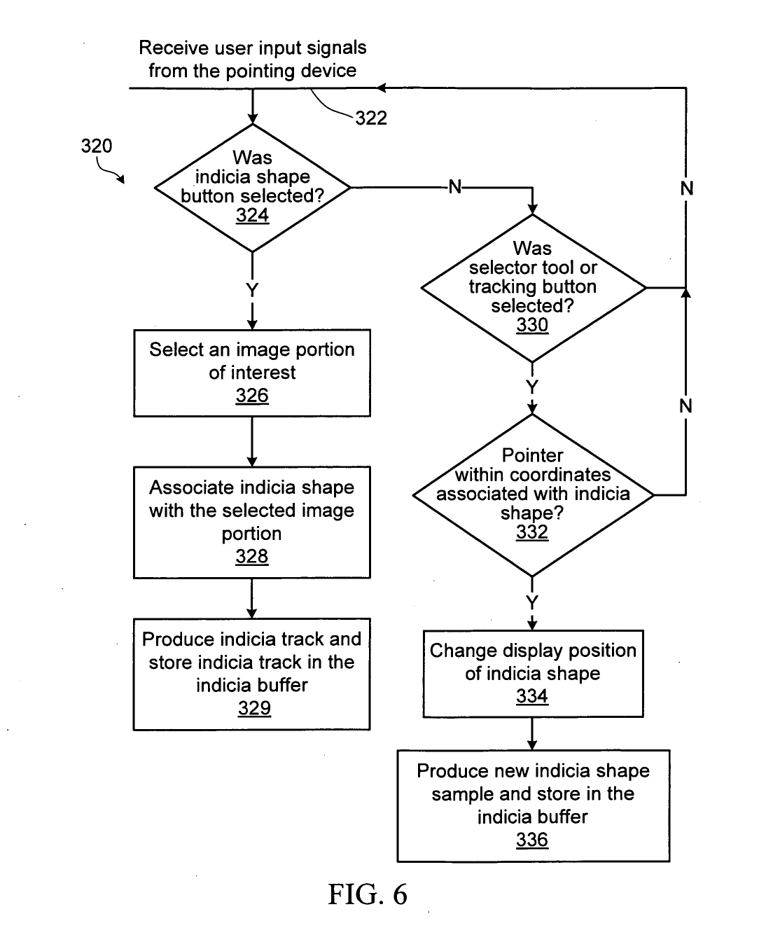

The process 300 begins at block 302, which directs the microprocessor 162 to perform a process for associating indicia with the image portion. This process is shown in greater detail at 320 in FIG. 6.

Associating Indicia with an Image Portion

Referring to FIG. 6, the process 320 begins at 322 when user input signals are received from the pointing device 184 at the input 180 of the I/O port 172 (shown in FIG. 2). Block 324 then directs the microprocessor to determine whether one of the indicia shape buttons 284 were selected before the user input signals were received, in which case the process continues at block 326.

Block 326 then directs the microprocessor 162 to select an image portion of interest (such as the image portion 270) in response to the user input signal. In one embodiment the user input signal may include a plurality of user input signals representing a movement of the pointing device 184 while an actuator button associated with the pointing device is actuated by the user, for example.

Block 328 directs the microprocessor 162 to associate the selected indicia shape with the selected image portion 270. In the embodiment shown in FIG. 4, the selected image portion 270 has a generally circular shape, and accordingly an oval indicia shape 282 is associated with the selected image portion. The indicia shape 282 further includes a plurality of shape handles 283 to facilitate reshaping the oval indicia shape to conform to the underlying selected image portion 270. The displayed indicia shape 282 is also at least partially transparent to facilitate simultaneous display of the underlying image portion 270. In other embodiments the indicia shape may include a rectangular or polygonal shape.

The process 320 then continues at block 329, which directs the microprocessor 162 to produce an indicia track. The indicia track is a video track having the same time-base as the video content. The indicia track includes a plurality of indicia variables for indicating actions to be taken when the indicia shape 282 is selected by a viewer of the interactive video content. The indicia track further includes a plurality of sequential samples including shape and position data identifying the position and shape of the indicia shape 282 at sequential times during the video content. In embodiments where the video content is produced in QuickTime format, the indicia track may be implemented as a sprite track and the indicia shapes may be sprites, as provided in the QuickTime video file format.

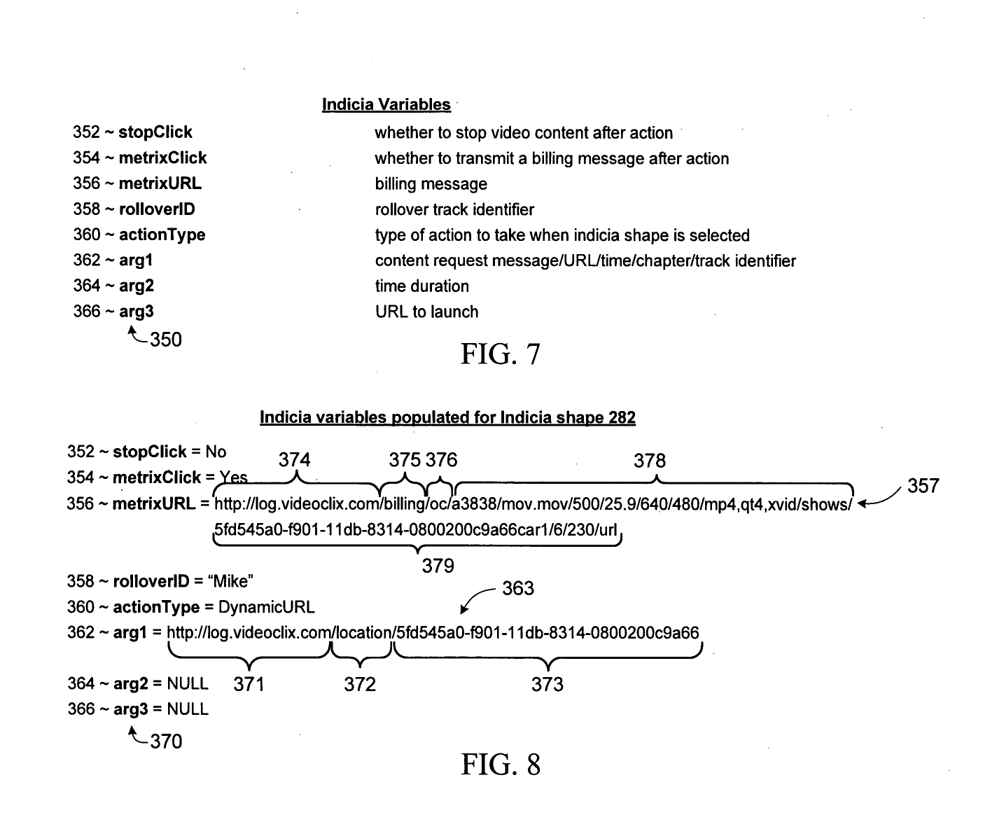

Referring to FIG. 7, an exemplary set of indicia variables are shown in tabular format generally at 350. The indicia variables 350 include a “stopClick” variable 352, a “metrixClick” variable 354, a “metrixURL” variable 356, and a “rolloverID” 358 for indicating various actions to be performed in response to user input selecting or associated with the indicia shape 282.

The indicia variables 350 include an “actionType” variable 360 for storing a type of action to be taken when the indicia shape is selected in response to user input received from a viewer of the interactive video content. The indicia variables 350 further include three data variables “arg1” 362, “arg2” 364, and “arg3” 366, each variable being associated with the action defined in the “actionType” variable 360. In this embodiment the “actionType” variable 360 is set to “dynamic URL” to cause transmission of a content location request to the registration server in response to selection of said indicia by a viewer of the interactive video content, and the content message is held in the “arg1” variable 362.

In other embodiments, the action type may include other actions such as requesting content associated with a fixed content location that is stored in the “arg1” variable 362 (e.g. www.disney.com). Alternatively, where the action type includes displaying text, the “arg1” variable 362 may include an identifier of a text track to be displayed, the “arg2” variable 364 may hold a time duration for which the text track should be displayed, and the “arg3” variable 366 may holds a content location to which a request for content should be transmitted once the text track has been displayed for the time duration held in the “arg2” variable.

In this embodiment, the “stopClick” variable 352 includes a Boolean value that indicates whether the interactive video content should be stopped or paused when the viewed selects the indicia shape 282.

The “metrixClick” variable 354 includes a Boolean value that indicates whether a billing message should be transmitted to a registration server in communication with the computer network 120. The billing message to be transmitted is held in the “metrixURL” variable 356, and causes the registration server to associate a billing entry with a sponsor account associated with the selected image portion to make a charge to the sponsor account as a result of the viewer selecting the indicia shape, as described in greater detail in Applicant's related U.S. provisional patent application 60/881,187 which is incorporated herein by reference.

The “rolloverID” variable 358 references a text track or a text string to be displayed when the viewer of the interactive video content moves the pointer 262 over the indicia shape 282, without selecting the indicia shape. In general the rollover text may include information associated with the selected image portion, such as a sponsor name, or an associated image portion name, for example.

An exemplary populated set of indicia variables for the indicia shape 282 is shown generally at 370 in FIG. 8. In this example the “stopClick” variable 352 “is set to “No” when a “Click Stop Video” checkbox 295 in the image portion inspector window 274 is not checked, thus indicating that the video content playback should not be stopped when the indicia shape 282 is selected.

The “metrixClick” variable 354 is set to “Yes” when a “Metrix reporting when clicked” checkbox 296 is checked. In this case, the corresponding “metrixURL” variable 356 holds the billing message 357 to be transmitted to the registration server 104 when the when the indicia shape 282 is selected.

The billing message 357 includes includes a first portion 374, a second portion 375, a third portion 376, a fourth portion 377, and a fifth portion 378.

The first portion 374 of the billing message 357 identifies a network address of the registration server 104. The second portion 375 of the billing message 357 identifies a script to be executed on the registration server. The script is generally operable to extract fields from the billing messages when received at the registration server 104.

The third portion 376 of the billing message 357 includes a type code, which may be either “oc” or “pb”. A type code of “oc” indicates that the billing message was sent in response to an object click. A type code of “pb” indicates that the billing message was sent in response to a tag embedded in the media file at a specific time in the media to indicate that the user has viewed the media up to and including this time.

The fourth portion 378 of the billing message 357 includes display condition information, such as video serial number, name, duration, size codecs used, and a category, as will be described later herein.

The fifth portion 530 of the billing message 520 includes an identifier identifying the image portion that was selected, as will be described later herein.

The “rolloverID” variable 358 is set to “Mike” when the Rollover display text” checkbox 297 is checked and the text “Mike” is entered into a “Rollover display text” user input box 298.

In this example the “actionType” variable 360 is set to “DynamicURL” when selected in the “URL” user input field 299, to indicate that the following “arg1” variable 362 includes a content location request message. The “arg2” and “arg3” variables 364 and 366 are not used when the “actionType” variable 360 is set to “DynamicURL and accordingly “arg1” and “arg2” are both set to “NULL” in this example.

Referring back to FIG. 6, block 329 further directs the microprocessor 162 to store the indicia track in the indicia buffer 222 in the RAM 166.

If at block 324, none of the indicia shape buttons 284 were selected before the user input signals were received, the process then continues at block 330. Block 330 directs the microprocessor 162 to determine whether the selector tool button 286 or the tracking button 288 was selected, in which case the process continues at block 332.

Block 332 directs the microprocessor 162 to determine whether a current pointer coordinate position is within the indicia shape 282, in which case the process continues at block 334. Block 334 directs the microprocessor 162 to cause the display position of the indicia shape 282 to be changed in response to the user input signal. In this embodiment, the indicia shape 282 is manually moved in response to user input to cause the indicia shape to follow the image portion 282 as the image portion changes display position in the display area 266.

The process then continues at block 336, which directs the microprocessor 162 to produce a new indicia sample, representing a new position of the indicia shape on the display area 266, and to store the new indicia sample in the indicia buffer 222. Referring to FIG. 4, a plurality of indicia samples are listed in tabular format at 290 in the image portion inspector window 274. The indicia samples 290 are also shown in graphical format at 292 on the timeline window. Each indicia sample 290 has an associated duration 294 and represents a position of the indicia shape for the time duration of the sample.

Referring back to FIG. 6, if at block 332 the current pointer coordinate position is not within the indicia shape 282, then the indicia shape is not moved and the process continues at 322.

Associating Image Portion Identifier with Indicia

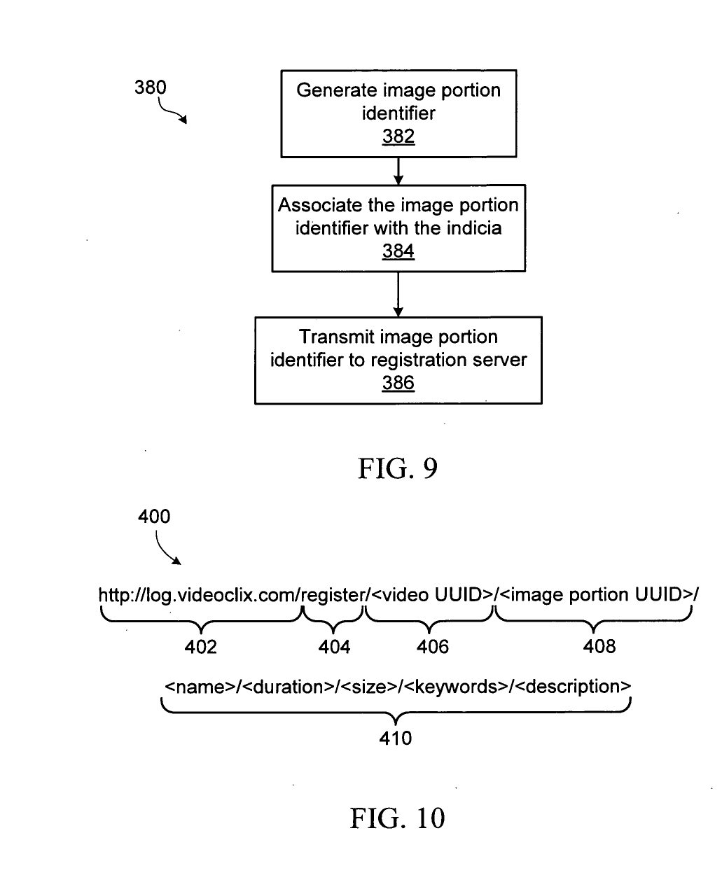

Referring back to FIG. 5, the process 300 continues at block 304, which directs the microprocessor 162 to perform a process for associating an identifier with the indicia. One embodiment of the process for associating the identifier with the indicia is shown in greater detail at 380 in FIG. 9.

Generating Image Portion Identifier

Referring to FIG. 9, the process 380 begins at block 382, which directs the microprocessor 162 to generate an image portion identifier. In one embodiment the microprocessor 162 generates a universally unique identifier (UUID). Generally, a UUID is a number that resulting from a concatenation of various identifiers and other information associated with the computer that has a negligible probability of duplicating another UUID generated by another computer. UUID functions are provided in many programming languages to facilitate generation of identifiers without requiring centralized coordination by a server.

The process 380 then continues at block 384, which directs the microprocessor 162 to associate the generated image portion identifier with the indicia shape 282 by writing a content location request 363 including the image portion identifier to the “arg1” variable 362 shown in FIG. 8.

Referring to FIG. 8, the content location request 363 includes a first portion 371 identifying a network address of the registration server 104, a second portion 372 identifying a script to be executed on the registration server, and a third portion 373 including the image portion identifier which in this example is “242E0931-C02A-4079-A5F9-5508D6C5F1CF”.

Referring back to FIG. 9, the process 380 then continues at block 386 which directs the microprocessor 162 to transmit an indicia registration request to the registration server to request registration of the indicia and the associated image portion identifier generated by the content publisher computer.

Referring to FIG. 10, an exemplary indicia registration request is shown generally at 400.

The indicia registration request 400 includes a first portion 402 identifying a location of the registration server and a second portion 404 identifying a script to be executed on the registration server 104. The indicia registration request 400 also includes an interactive video content identifier 406, which may be a UUID as described later herein. The indicia registration request 400 further includes an image portion identifier 408, which in this embodiment comprises the image portion UUID generated in the process 380 shown in FIG. 9.

In this embodiment, the indicia registration request 400 also includes an image portion attribute indicator 410, which includes a plurality of attributes of the selected image portion 270. In the example shown in FIG. 10, the image portion attribute indicator 410 includes a name of the image portion 270 (e.g. “Mike” ), a duration for which the image portion is displayed, a size of the image portion in pixels, keywords associated with the image portion provided by a user of the content publisher computer 102, and a description of the image portion provided by the user of the content publisher computer.

In one embodiment, the indicia registration request 400 may be formatted as a Hypertext Transfer Protocol (HTTP) GET method and transmitted to the registration server 104 using transmission control protocol over internet protocol (TCP/IP). In this embodiment, the content publisher computer 102 first opens a socket to the host identified by the first portion 402 of the indicia registration request 400, and then transmits the portions 404, 406, 408, and 410 to the host in a HTTP GET message, where the parameters 406-408 are directly encoded in the URL portion of the get message.

In other embodiments, the indicia registration request may be formatted as an HTTP POST, in which case the data portions 406, 408, and 410 would be included in the HTTP message payload.

Advantageously in the embodiment shown in FIG. 9 and FIG. 10, by generating the image portion identifier on the content publisher computer 102 as a UUID the image portion 270 may be associated with and the image portion identifier in the interactive video content while the content is being produced. The registration of the image portion and association of the image portion identifier with the image portion by the registration server 104 may be completed in response to the indicia registration request 400 while the interactive video content is being produced, or after the content production has been completed.

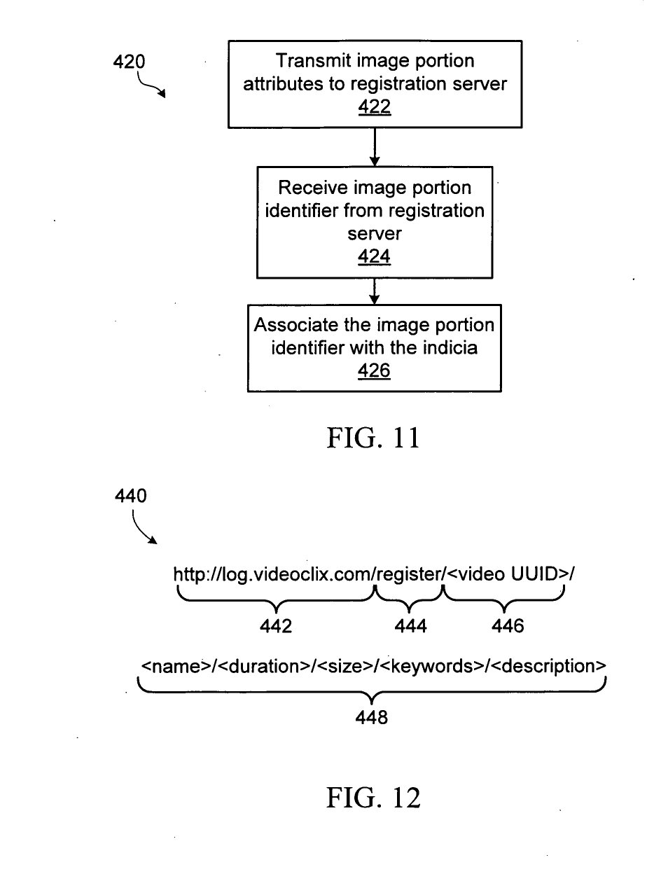

In other embodiments, the indicia registration request may include a plurality of image portion identifiers associated with a respective plurality of image portions. Referring back to FIG. 5, an alternate embodiment for associating the identifier with the indicia (block 304 in FIG. 5) is shown in greater detail at 420 in FIG. 11.

The process 420 begins at block 422, which directs the microprocessor 162 to transmit the image portion attributes of the image portion 270 to the registration server 104.

In general the image portion attributes include information identifying occurrences of the image portion 270 in the video content, including attributes such as the attributes 410 described above in connection with FIG. 10. In this embodiment, the indicia registration request include all the be identical to

Referring to FIG. 12, an exemplary indicia registration request corresponding to the embodiment shown in FIG. 11 is shown generally at 440 in FIG. 12. The indicia registration request 440 may be formatted as a HTTP GET method and transmitted to the registration server 104 using TCP/IP.

The indicia registration request 440 includes a first portion 442 identifying a location of the registration server and a second portion 444 identifying a script to be executed on the registration server 104. The indicia registration request 440 also includes an interactive video content identifier 446, which may be a UUID as described later herein. The indicia registration request 440 also includes an image portion attribute indicator 448, which includes a plurality of attributes of the selected image portion 270. In the example shown in FIG. 12, the image portion attribute indicator 448 includes a name of the image portion 270 (e.g. “Mike”), a duration for which the image portion is displayed, a size of the image portion in pixels, keywords associated with the image portion by a user of the content publisher computer 102, and a description of the image portion provided by the user of the content publisher computer.

Referring back to FIG. 11, the process 420 then continues at block 424, which directs the microprocessor 162 to receive an image portion identifier from the registration server 104. In this embodiment, the image portion identifier is received in an HTTP response from the registration server 104, in response to the HTTP GET transmitted to the registration server by the content publisher computer 102 at block 422.

Block 426 then directs the microprocessor 162 to associate the image portion identifier received from the registration server 104 with the indicia shape 282 by writing the content location request 363 including the image portion identifier to the “arg1” variable 362, as shown in FIG. 8. In this embodiment the content location request has the same format as the content location request shown in FIG. 8, except that the third portion 376 of the content location request need not be a universally unique identifier, since in this embodiment the identifier is generated by the registration server 104, as will be described later herein.

Associating Link Properties with Indicia

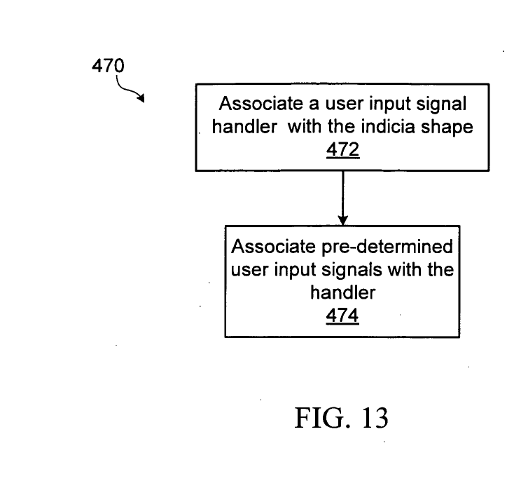

Referring back to FIG. 5, the process 300 continues at block 306, which directs the microprocessor 162 to perform a process for associating link properties with the indicia. The process for associating link properties is shown in greater detail at 470 in FIG. 13.

The process begins at block 472 which directs the microprocessor 162 to associate a user input signal handler with the indicia shape. Block 474 then directs the microprocessor 162 to associate pre-determined user input signals with the handler. In a QuickTime video format, each of the associations of blocks 472 and 474 are performed by storing QuickTime data structures known as atoms in the indicia track stored in the indicia buffer 222. The atoms include codes that cause the associations 472 and 474 to be made.

In one embodiment, where the interactive video content is produced in QuickTime format a “Mouse click” user input signal is associated with the handler, such that when a viewer of the interactive video content actuates an actuator button on the pointing device 184 (shown in FIG. 2) while a pointer is over the indicia shape (or sprite), then the user input signal handler is launched. The handler generally includes codes for directing the microprocessor 162 to read the content location request 363 (shown in FIG. 8) and to cause the message to be transmitted to the registration server 104.

QuickTime provides various functions for producing interactive content, as described in greater detail in the document “Interactive Movies” ©Apple Computer Inc 2003 and 2002, and which is incorporated herein by reference.

Referring back to FIG. 5, the process 300 continues at block 308, which directs the microprocessor 162 to write the interactive video content to a video file.

Producing the Interactive Video File

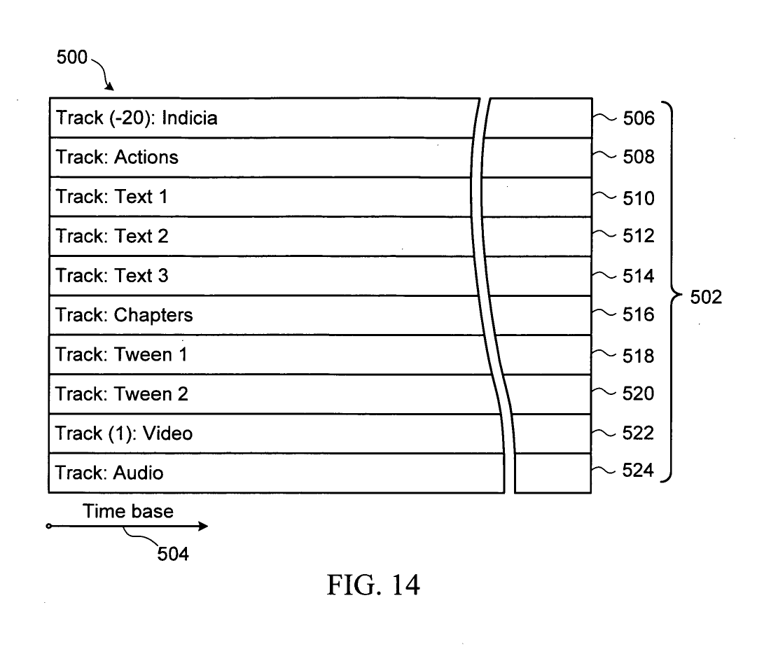

Referring to FIG. 14, a schematic representation of a QuickTime video file produced using the VideoClix software product is shown generally at 500.

QuickTime video files generally include a plurality of tracks 502 having track indexes ranging from −32768 to 32768. The tracks 502 are all sequenced to a common time base 504 having unit time increments. The time increment of the time base 504 may be 1/600 of a second, for example.

Tracks 502 having lower index numbers are displayed in front of tracks having higher numbers. For example the track “−20” is displayed in front of the track “0”. Commonly used tracks may include video and audio media, but QuickTime files may also include text tracks, chapter tracks, and sprite tracks, for example.

Each track 502 includes a plurality of samples, which are defined by data structures known as a QuickTime “Atoms”. The QuickTime Atom data structure is explained in greater detail in the document “QuickTime Movie Basics” ©Apple Computer Inc 2005 and 2006, and which is incorporated herein by reference. QuickTime samples are of variable data size, and accordingly QuickTime atoms are also of variable data size. QuickTime atoms may act as containers for other atoms in a hierarchical data structure, and a QuickTime video (or so-called “movie” ) generally includes an atom container for the whole movie, and a container for each track.

Since the QuickTime media file may include data references to media data stored in different network locations, such data references need to be resolved before displaying the sequenced media. In some embodiments, it may be desirable to provide a single file including all media data for downloading over the network. Such a video file, which has resolved all references to media data stored in other network locations, is known as a flattened file. Flattened files may be played on any client display device without requiring any additional media data from other locations. While computers running Apple Macintosh operating systems may be able to resolve such data references for QuickTime .mov files, computers running Microsoft Windows® operating system generally require flattened QuickTime files for displaying sequenced media content in a QuickTime media player window.

Samples in a track 502 are generally compressed in size by defining a “keyframe” sample that includes all data to be displayed, followed by a plurality of override samples, which include only updates or changes from the keyframe sample. Accordingly override samples generally include only a portion of the data included in a keyframe sample, thus facilitating compression video content. Script handler atoms for handling various interrupt signals produced by the viewer of the video content are included in the keyframe sample atoms.

QuickTime provides for interactivity in video content, through inclusion of “sprite tracks” and a plurality of functions that facilitate the creation of interactive sprites. In computer graphics, a sprite is an image or animation that is integrated into a larger scene. The sprite track may include one or more sprites that have associated properties defining their location, shape, and visibility, for example. In QuickTime embodiments the image portion indicia are implemented as sprites. In other embodiments, such as Flash for example, the image portion indicia may be implemented using different functions provided in the respective video content creation platforms.

In QuickTime, each sprite defined in a sprite track has properties that describe its location and appearance at a given time as displayed on the background of the sequenced media (commonly referred to as a “sprite world” or more simply a “stage”). QuickTime sprites may be visible or invisible and may be modified to cause the sprite to change appearance and/or to move around the stage.

In this embodiment, the QuickTime video file 500 includes an indicia track 506, which is a sprite track having a layer number of “−20”. The indicia track 506 has a single keyframe sample (not shown) at the beginning of the track that defines a circle base image and a rectangle base image.

The circle and the rectangle base images are used, with appropriate scaling and position transformations, to produce the indicia shapes such as the indicia shape 282. In this embodiment, the circle and rectangle base images are not visible in the interactive video content, but may be made visible to the user of the content production computer 102 to facilitate production of the interactive content.

The keyframe sample of the indicia track 506 further includes a data Atom for each indicia shape that is defined in the indicia track 506. The data Atom includes the indicia variables 350 shown in FIG. 7 (i.e. for the indicia shape 282, the associated data atom would include the indicia variables 370, shown in FIG. 8).

The indicia shape is associated with the image portion 270 in the video content by applying a transformation matrix to the base image shape boundaries to produce the indicia shape 282, such that the position and shape of the indicia shape generally corresponds to the image portion 270, as the image portion moves about the display area. The transformation matrix is contained in a data atom, and is populated with values for causing translation, rotation, scaling, and other arbitrary geometric distortions to the base image.

The VideoClix interactive content authoring software produces successive transformation matrix values in response to user input that causes the indicia shape 282 to change position and/or shape. Each time the position, shape, or size of the indicia shape changes, a current sample defining the indicia shape is ended and a new sample is created and added to the indicia track 506. The new sample includes updated values for the transformation matrix stored in data atoms.

The indicia track 506 further includes handler scripts included as atoms in the keyframe sample atom. The handler scripts include codes for directing a processor circuit associated with a client display device on which the video content is being viewed, to handle user input from a viewed of the interactive video content that is associated with the indicia shapes that are defined in the indicia track 506.

For example, when a viewer of the interactive video causes a pointer to move over an indicia shape, QuickTime sends a “mouse enter” event message to the indicia shape. The indicia track 506 includes a QuickTime handler script “kQTEventMouseEnter” (not shown) which is associated with the indicia shape for handling the “mouse Enter” event message. Thus, when a viewer of the interactive video causes a pointer to move over an indicia shape the “kQTEventMouseEnter” handler script is launched and causes certain pre-defined actions to be performed such as displaying a rollover text track.

When a viewer of the interactive video causes a pointer to move over an indicia shape, and then actuates and releases a pointer actuator button, a “mouse click end trigger button” event message is sent to the indicia shape. The indicia track 506 also includes a handler script “kQTEventMouseClickEndTriggerButton” which is associated with the indicia shape for handling the “mouse click end trigger button” event message. When launched the “kQTEventMouseClickEndTriggerButton” handler script reads the indicia variables 370 and performs actions defined for the indicia shape in the indicia variables.

If the metrixClick indicia variable 354 is set to “yes” then a “kActionListServerQuery” script included in the indicia track 506 is launched. The “kActionListServerQuery” script generally causes the content location request 363 and the billing message 357 to be transmitted to the registration server 104. The indicia track further includes a content location response handler script for handling a content location message response from the registration server.

The keyframe sample of the indicia track 506 also includes a “kQTEventFrameLoaded” script, which causes the indicia variables 370 (shown in FIG. 8), the image index (1 for circle base image and 2 for rectangle base image), and the transformation matrix, to be initialized when the video content is played.

The video file 500 may also include a timed actions track 508, which is an invisible sprite track, but which has no actual sprites. The timed actions track 510 generally defines timed actions that happen at a specific time regardless of user input, such as displaying a user menu displaying possible user selections for viewing the sequenced media. The timed actions track 510 is broken up into samples that extend between each non-sprite action defined for the media. The timed actions track 510 further includes a “kQTEventFrameLoaded” script, which causes arguments associated with the non-sprite actions to be loaded at beginning of each sample.

The video file 500 may also include a plurality of text tracks. In the embodiment shown in FIG. 14, the video file 500 includes three text tracks 510, 512, and 514. Each text track defines a single text object having a configurable position, size, and text display specification.

The video file 500 further includes a chapters track 516, which is an invisible text track including samples having a duration corresponding to chapters in the video file. Each chapter track sample includes a name of the chapter and facilitates changing a displayed portion of the video file in response to selection of a specific chapter by the user.

The video file 500 may also include one or more tween tracks. In the embodiment shown in FIG. 14 there are two tween tracks 518 and 520. Tween tracks are useful for defining the position, shape and/or size of an indicia shape in the indicia track 506 that changes generally linearly between sequential samples. When an indicia shape is set to “tween” between samples, a tween track is created for it. The tween track causes appropriate modifier atoms to be included in the indicia track 506, such that indicia shape is appropriately transformed. Tween tracks reduce the amount of data necessary to cause an indicia shape to move with an associated image portion when the image portion moves in a generally linear fashion between two sequential samples in the indicia track.

In some embodiments the video and/or audio tracks may be loaded from an external HTTP server or streamed from an RTSP or RTMP server (not shown) implemented on the video server 106 shown in FIG. 3. In such cases when the video file is produced, a Uniform Resource Locator (URL) is included in the file and a video track 524 is added to the video file 500 on playback. In this case the video track 524 has a sample of the same the length as the video content and includes the RTSP, RTMP or HTTP URLs.

In other embodiments where an RTSP, RTMP, or HTTP server is not available for loading or streaming the video content to the viewers, video content from the source video file source may be copied to the video track 524 of the video file 500. Similarly, audio data may also be copied from the source media to an audio track 522 of the video file 500.

In general, the video file 500 may also include a track (not shown) including general movie flags and data for controlling auto-playing of the media, whether the user is able to save the video file on the client display device, full screen presentation flags, and looping flags, for example.

Interactive Video Registration

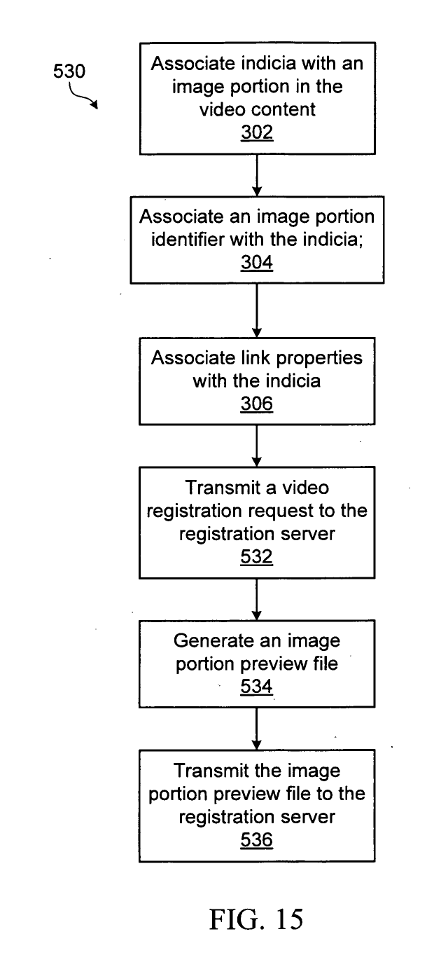

Referring to FIG. 15 a process flowchart including blocks of code for directing the processor circuit 160 to produce interactive video content in accordance with an alternative embodiment is shown generally at 530.

The process 530 includes the blocks of code 302, 304, and 306 as described above and further includes a block of codes 532 for directing the microprocessor 162 to transmit a video registration request to the registration server 104 to request registration of the interactive video content. Block 532 directs the microprocessor 162 to generate a UUID for the interactive video file, generally as described above in connection with the image portion identifier. Block 532 also directs the microprocessor 162 to generate a video registration request.

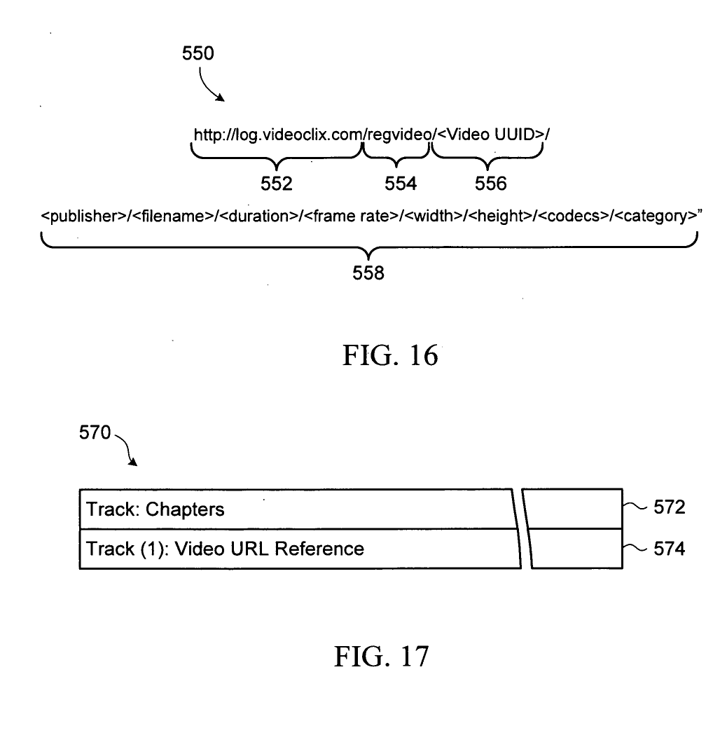

Referring to FIG. 16, an exemplary format of a video registration request is shown generally at 550. The video registration request 550 may be formatted as a Hypertext Transfer Protocol (HTTP) GET method and transmitted to the registration server 104 using transmission control protocol over internet protocol (TCP/IP).

The video registration request 550 includes a first portion 552 identifying a location of the registration server and a second portion 554 identifying a script to be executed on the registration server 104. The video registration request 550 also includes a video file identifier 556, which may be a UUID as described above.

In this embodiment, the video registration request 550 also includes a video file attribute indicator 558, which includes a plurality of attributes of the video file. In the example shown in FIG. 16, attribute indicator 558 includes an identifier identifying a content publisher operating the content production computer 102 to produce the interactive video content. The attribute indicator also includes a filename associated with the video file, a duration of the video content, a number of frames per second associated with the video content, a width and height of the video in pixels, a video compression/decompression algorithm (codec) associated with the interactive video content in the video file, an audio compression/decompression algorithm (codec) associated with audio content in the video file and a video category indicator associated with the video content.

Image Portion Preview

Referring back to FIG. 15, the process then continues at block 534, which directs the microprocessor 162 to generate an image portion preview file.

Referring to FIG. 17, a schematic representation of an image portion preview file in QuickTime format is shown generally at 570. The image portion preview file includes a chapter track 572, which includes text identifiers identifying chapters for each occurrence of the image portion 270 in the interactive video content. For example, the image portion 270 may only be displayed during certain portions of the video content, and the chapters track is used to identify each entry of the image portion into the display area 266, to facilitate previewing the image portion. If the image portion 270 is displayed for the entire duration of the video content, then only a single chapter will be included in the chapter track 572.

The image portion preview file 570 further includes a reference track, which includes a reference to a network location of the video file. For example, in an embodiment where the interactive video content is written to a video file on the video server 106, the network location may be a URL identifying the location of the video file on the video server.

Referring back to FIG. 15, the process then continues at block 536, which directs the microprocessor 162 to transmit the image portion preview file to the registration server 104. In this embodiment, the image portion preview file is transmitted to the registration server in the payload of the indicia registration request shown in FIG. 10.

Registration Server

Processor Circuit

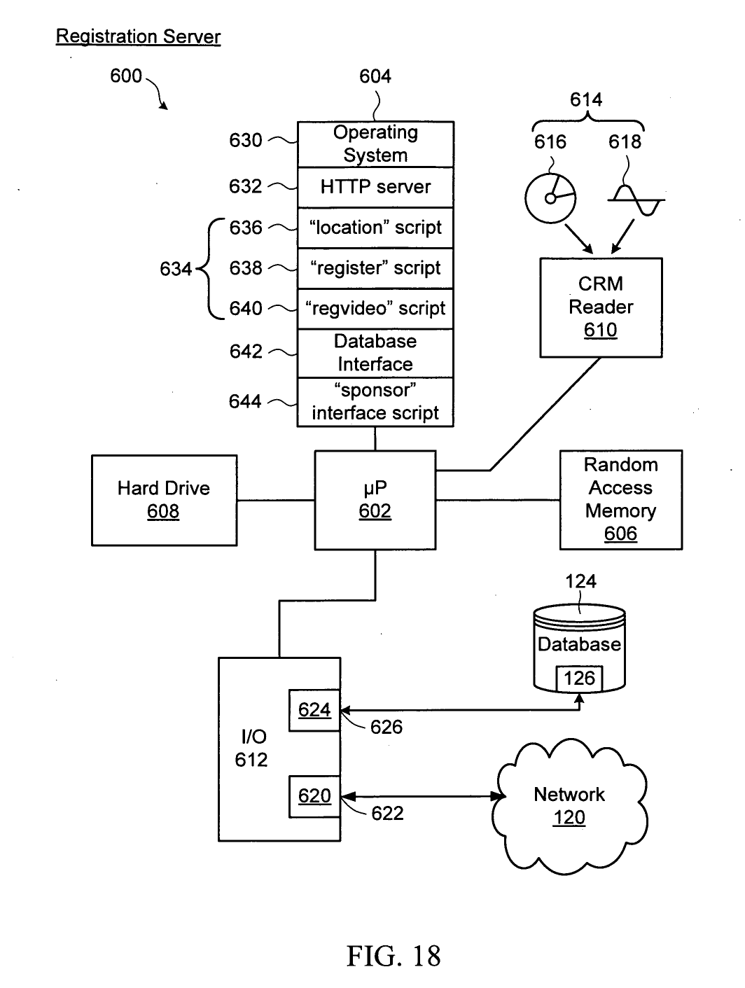

Referring to FIG. 18, in one embodiment the registration server 104 may be implemented using a processor circuit shown generally at 600. The processor circuit 600 includes a microprocessor 602, a program memory 604, a random access memory (RAM) 606, a hard drive 608, a computer readable medium (CRM) reader 610, and an input output port (I/O) 612, all of which are in communication with the microprocessor 602.

The CRM reader 610 facilitates loading program codes into the program memory 604 from a computer readable medium 614, such as a CD ROM disk 616, or a computer readable signal 618, such as may be received over a network such as the internet, for example.

Program codes for directing the microprocessor 602 to carry out various functions are stored in the program memory 604, which may be implemented as a random access memory (RAM), and/or a hard disk drive (HDD), or a combination thereof. In this embodiment the program memory 604 includes a first store 630 for storing program codes for directing the microprocessor 602 to provide various operating system functions, and a second store 632 for storing program codes for directing the microprocessor 602 to implement a hyper text transfer protocol (HTTP) server.

The program memory 604 also includes a plurality of database parser stores 634 for storing program codes for directing the microprocessor 602 to parse messages into fields and to interface with the database management system 126 of the database 124. The database parser stores 634 include a store 636 for storing a “location” script, a store 638 for storing a “register” script, and a store 640 for storing a “regvideo” script. The program memory 604 further includes a store 642 for storing database interface program codes for implement an interface to the database 124.

The program memory 604 further includes a store 644 for storing sponsor interface program codes for implementing an interface for the sponsor computer 108 to view image portions such as the image portions 270 and 272 that are available for sponsoring.

The I/O 612 includes an interface 620 having an input/output 622, which is in communication with the network 120 for receiving messages from the other computers in communication with the network. The interface 620 may include an Ethernet interface, for example.

The I/O 612 also includes an interface 624 having an input/output 626, which is in communication with the database 124 through the database management system 126. The interface 624 may include an Ethernet interface, for example.

In one embodiment the registration server 104 may be implemented using a plurality of processor circuits such as the processor circuit 600, and a central server or a virtual server (not shown) may implement load balancing to redirect a communications connection to one of the plurality of processor circuits, depending on which is able to provide a quickest response. Load balancing techniques are well known in the art.

Database Processor Circuit

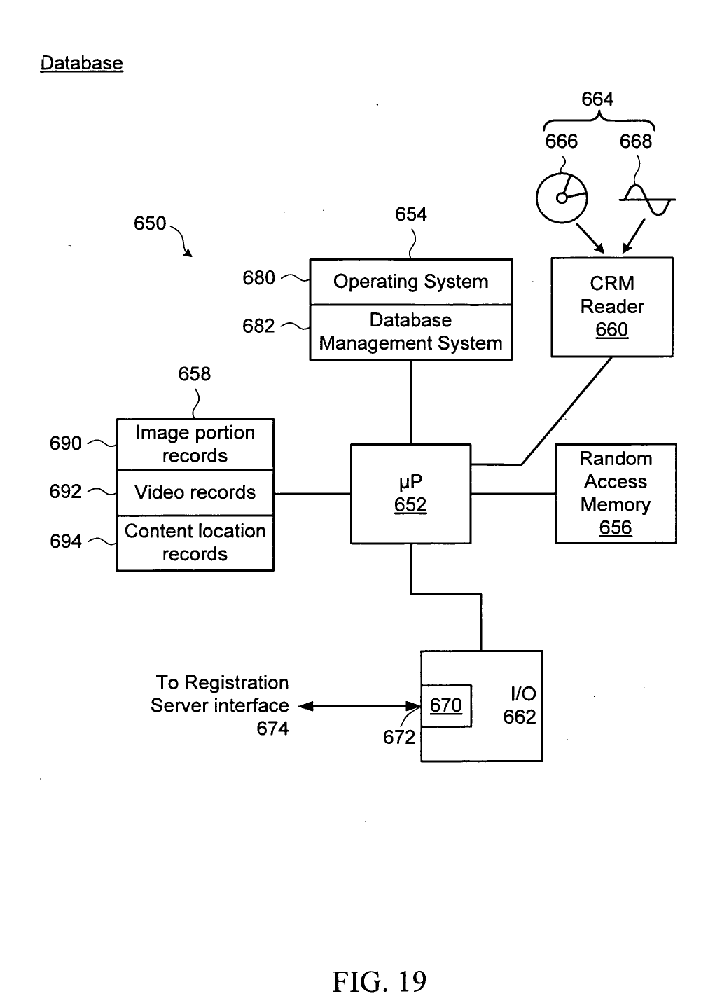

Referring to FIG. 19, in one embodiment the database 124 may be implemented using a processor circuit shown generally at 650. The processor circuit 650 includes a microprocessor 652, a program memory 654, a random access memory (RAM) 656, a hard drive 658, a computer readable medium (CRM) reader 660, and an input output port (I/O) 662, all of which are in communication with the microprocessor 652.

The CRM reader 660 facilitates loading program codes into the program memory 654 from a computer readable medium 664, such as a CD ROM disk 666, or a computer readable signal 668, such as may be received over a network such as the internet, for example.

Program codes for directing the microprocessor 652 to carry out various database functions are stored in the program memory 654, which may be implemented as a random access memory (RAM), and/or a hard disk drive (HDD), or a combination thereof. In this embodiment the program memory 654 includes a first store 680 for storing program codes for directing the microprocessor 652 to provide various operating system functions. The program memory also includes a second store 682 for storing program codes for directing the microprocessor 652 to implement the database management system 126 (shown in FIG. 1), such as a Structured Query Language (SQL) server.

The I/O 662 includes an interface 670 having an input/output 672, which is in communication with the interface 624 of the registration server processor circuit 600, shown in FIG. 18.

The hard drive 658 includes a plurality of stores including a first store 690 for storing image portion records, a second store 692 for storing video records, and a third store 690 for storing content location records. In one embodiment the hard drive 658 may include a redundant array of independent disks (RAID) to provide improved fault tolerance over a conventional hard drive.

Processing Video Registration Requests

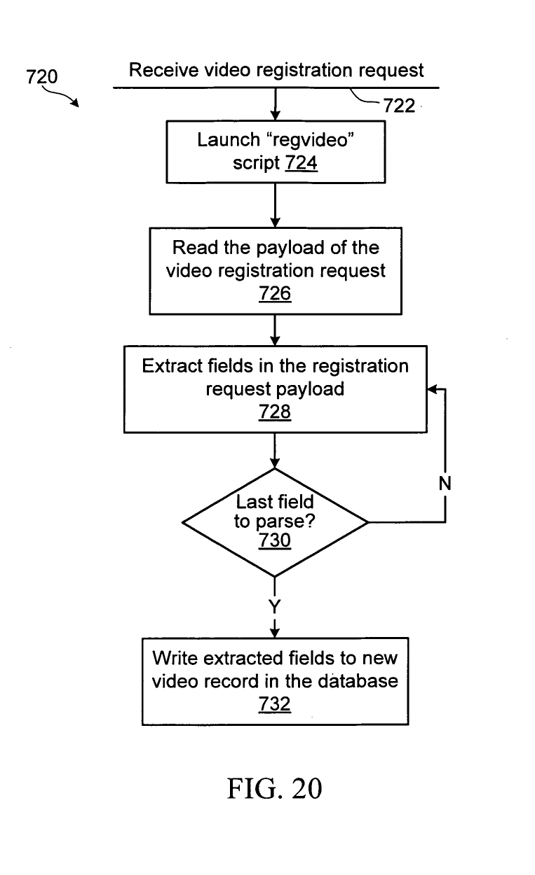

Referring to FIG. 20 a process flowchart including blocks of code for directing the registration server processor circuit 600 to register a new interactive video file is shown generally at 720.

The process begins at 722 when the video registration request 550 (shown in FIG. 16) is received from the content publisher computer 102.

Block 724 directs the microprocessor 602 to launch the “regvideo” script program codes 640 in the program memory 604 (shown in FIG. 18).

Block 726 then directs the microprocessor 602 to read the payload of the video registration request 550 (i.e. field 556, and the attribute fields 558).

The process then continues at block 728, which directs the microprocessor 602 to successively extract the field 556 and the plurality of attribute fields 558 in the video registration request 550.

Block 730 then directs the microprocessor 602 to determine whether the last field extracted was the last field in the video registration request 550, in which case the process continues at block 732.

Block 732 then directs the microprocessor 602 to write the extracted fields to a new video record in the database 124.

If at block 730 the last field parsed is not the last field in the video registration request 550, then the process continues at block 728 as described above.

In one embodiment the “register” script comprises a hypertext preprocessor (PHP) server side script, which provides functions for interfacing with many different database management systems such as MySQL, for example. PHP scripting language provides functions for connecting to a MySQL database (e.g. “mysql_connect”), and for querying the database to read fields in records or write new records (e.g. mysql_query).

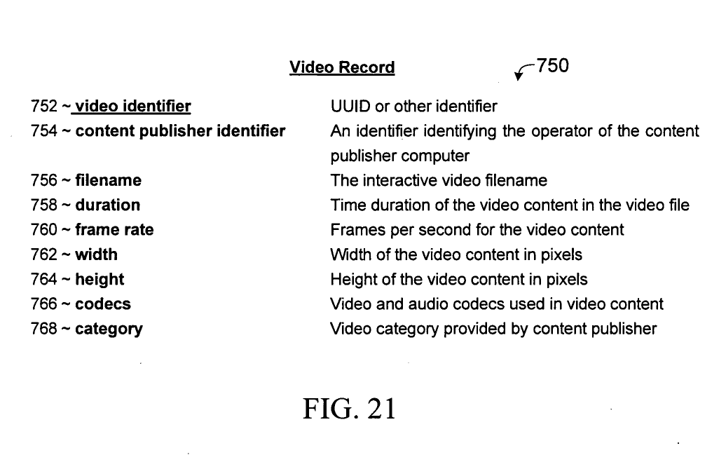

Referring to FIG. 21, an exemplary format of a video record is shown generally at 750. The video record 750 generally includes fields that correspond to fields in the video registration request 550, including an video identifier field 752 which is used as the primary key association for the video record to facilitate association with other records described later herein. The video record 750 further includes a content publisher identifier field 754, a filename field 756, a duration filed 758, a frame rate field 760, a width field 762, a height field 764, a codecs field 766, and a category field 768.

Referring to FIG. 19, the database management system program codes direct the database processor circuit 650 to receive the extracted fields of the to cause the video record 750 to be created and stored in the video record store 692. In one embodiment the database management system 126 is implemented as a MySQL database management system.

Processing Indicia Registration Requests

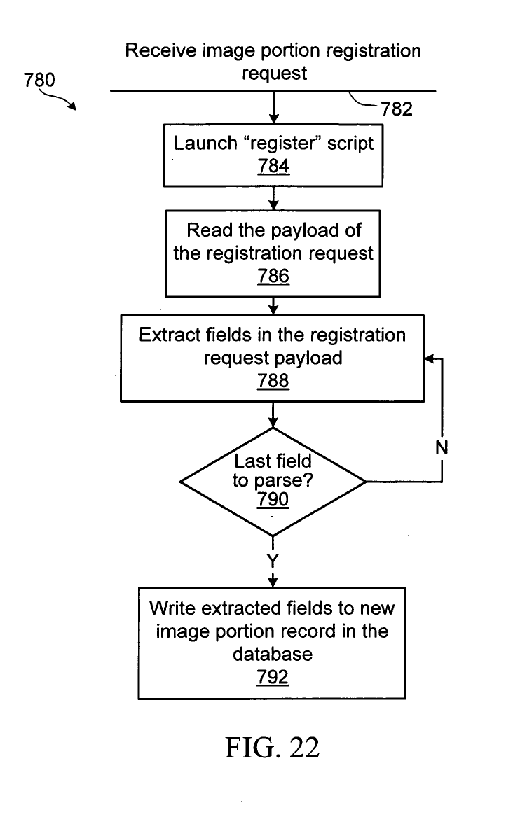

Referring to FIG. 22 a process flowchart including blocks of code for directing the registration server processor circuit 600 to register an image portion such as the image portion 270 is shown generally at 780.

The process begins at 782 when the indicia registration request 400 (shown in FIG. 10) is received from the content publisher computer 102.

Block 784 directs the microprocessor 602 to launch the “register” script program codes 638 in the program memory 604 (shown in FIG. 18).

Block 786 then directs the microprocessor 602 to read the payload of the indicia registration request 400 (i.e. fields 406, 408, and the attribute fields 410).

The process then continues at block 788, which directs the microprocessor 602 to successively extract each of the fields 404, 408, and the plurality of attribute fields 410 in the indicia registration request.

Block 790 then directs the microprocessor 602 to determine whether the last field extracted was the last field in the indicia registration request, in which case the process continues at block 732.

Block 792 then directs the microprocessor 602 to write the extracted fields to a new image portion record in the database 124.

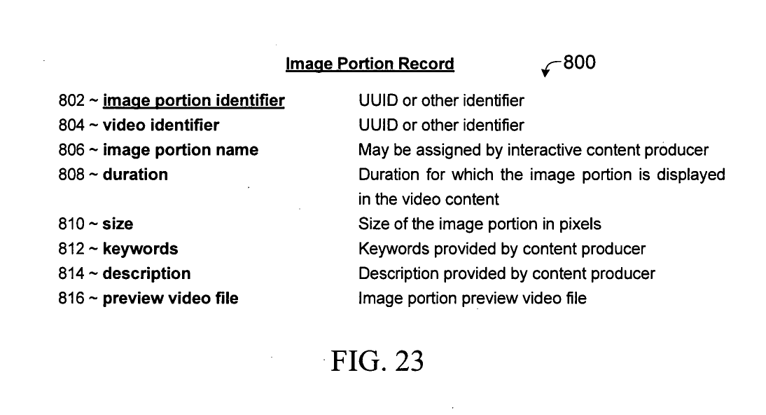

Referring to FIG. 23, an exemplary format of an image portion record is shown generally at 800. The image portion record 800 generally includes fields that correspond to fields in the indicia registration request 400, including an image portion identifier field 802 which is used as the primary key association for the image portion record to facilitate association with other records described later herein. The image portion record 800 further includes a video identifier field 804, an image portion name field 806, a duration field 808, a size field 810, a keywords field 812, and a description field 814. In embodiments where the content publisher computer 102 produces the preview video file 570 (shown in FIG. 17), the image portion record 800 further includes a video preview field 816.

Referring to FIG. 19, the database management system program codes 684 direct the database processor circuit 650 to receive the extracted fields and cause the image portion record 800 to be stored in the image portion record store 690.

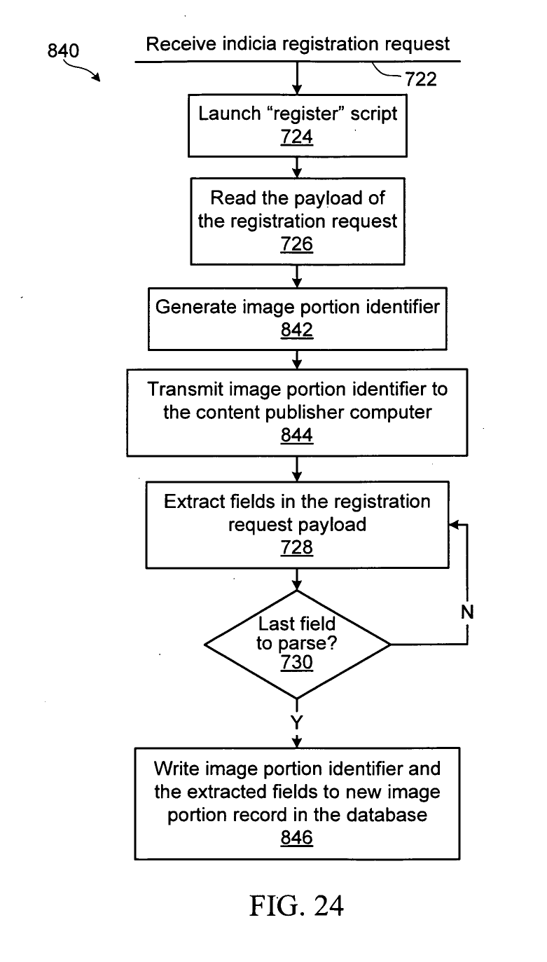

Referring to FIG. 24 a process flowchart including blocks of code for directing the registration server processor circuit 600 to register an image portion in accordance with an alternative embodiment is shown generally at 780. The process corresponds to the embodiment shown in FIG. 11, in which the indicia registration request does not include an image portion identifier.

Blocks 722-726 of the process 840 are identical to the like numbered blocks in the process 780 shown in FIG. 22 and described above. Block 842 then directs the microprocessor 602 to generate an image portion identifier. In this embodiment, allocation of image portion identifiers is controlled by the registration server and accordingly the image portion identifier need not be universally unique, but must be unique to the system 100. Accordingly, block 842 may direct the microprocessor 602 to generate a next serial number in an ordered sequence of serial numbers.

Block 844 then directs the microprocessor 602 to transmit the image portion identifier to the content publisher computer 102. In one embodiment, where the indicia registration request is in the form of an HTTP GET message, the image portion identifier may be transmitted to the content publisher computer 102 in the a response to the HTTP GET message. Alternatively, a separate HTTP GET message may be transmitted to the content publisher computer 102.

Blocks 728 and 730 of the process 840 are identical to the like numbered blocks in the process 780 shown in FIG. 22 and described above.

Block 846 then directs the microprocessor 602 to write the image portion identifier generated at block 842 and the extracted fields to a new image portion record in the database.

Referring back to FIG. 23, the new image portion record may identical to the image portion record 800. However in this embodiment, the image portion identifier field 804 may hold an identifier value that is not a UUID value.

Advantageously, the registration server receives indicia and video registration requests from a plurality of content publisher computers, such as the content publisher computer 102, and produces and stores a plurality of image portion records 800 and video records 750 in the image portion record database store 690 and the video record database store 692 respectively. Each interactive video file may thus have an a plurality of image portion records 800 associated with the interactive video content. The image portion records 800 generally represent image portions that occur in interactive video content located on any video server in communication with the network 120 (such as the video server 106) and are available for sponsorship by an advertiser who wishes to associate a product or service with the image portion.

Sponsor Computer and Client Display Device Processor Circuit

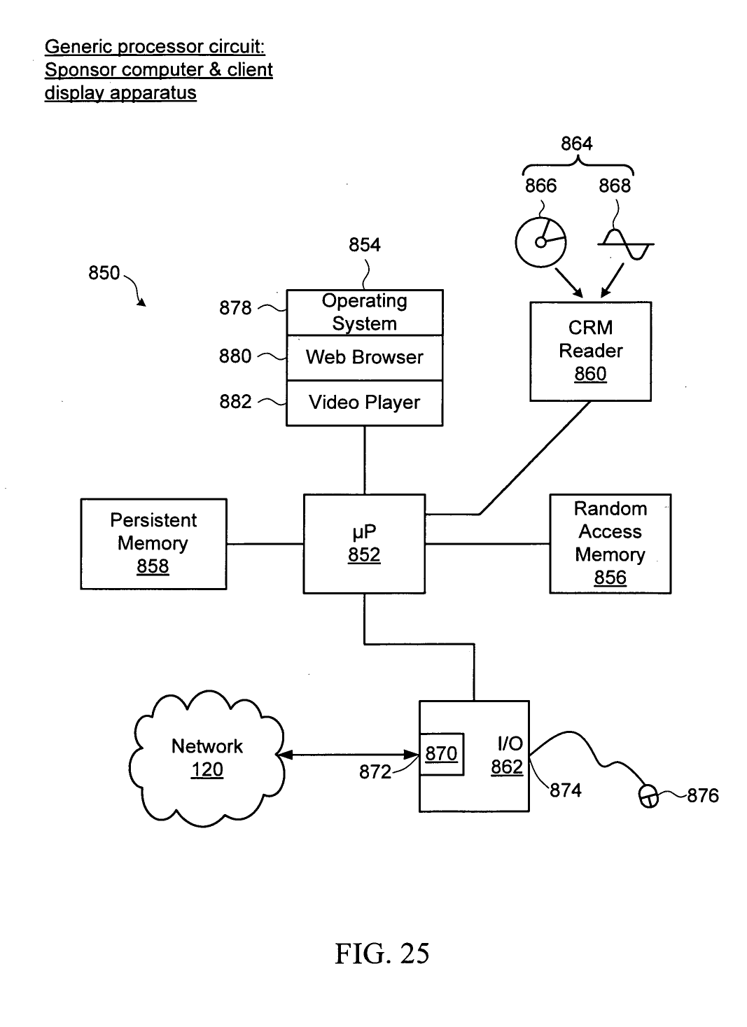

Referring to FIG. 25, an exemplary generic processor circuit for implementing either the sponsor computer 108 or any of the client display devices 110, 112, 114, or 116 is shown generally at 850. The processor circuit 850 includes a microprocessor 852, a program memory 854, a random access memory (RAM) 856, an optional persistent memory store 858, a computer readable medium (CRM) reader 860, and an input output port (I/O) 862, all of which are in communication with the microprocessor 852.

The CRM reader 860 facilitates loading program codes into the program memory 854 from a computer readable medium 864, such as a CD ROM disk 866, or a computer readable signal 868, such as may be received over a network such as the internet, for example.

Program codes for directing the microprocessor 852 to carry out various functions are stored in the program memory 854, which may be implemented as a random access memory (RAM), and/or a hard disk drive (HDD); or a combination thereof. In this embodiment the program memory 854 includes a first store 878 for storing program codes for directing the microprocessor 852 to provide various operating system functions, a second store 880 for storing program codes for directing the microprocessor 852 to launch a web browser application for viewing Hypertext Markup Language (HTML) pages, and a third store 882 for storing program codes for directing the microprocessor 852 to implement a video player for displaying video content on the respective displays 148, 13, 132, 134, and 136 of the sponsor computer 108 and the client display devices 110, 112, 114, and 116.

The RAM 856 and/or the persistent store 858 provide storage for downloaded video files, and/or for buffering video content data when playing streaming video files. The persistent store 858 may include a hard drive or a flash memory, for example.

The I/O 862 includes an interface 870 having an input/output 872 in communication with the network 120. The interface 870 may include an Ethernet interface, for example, and the interface may be in communication with the network 120 through a wired or a wireless communications link.

The I/O 862 includes an input 874 for receiving user input signals from a pointing device 876, such as a computer mouse.

When a sponsor using the sponsor computer 108 wishes to view image portions that are available, the sponsor launches the web browser program codes 880 and enters a URL into the web browser address field. The URL may be a URL of a sponsor image portion search web page on the registration computer 104. The browser program codes 880 then direct the microprocessor 852 to transmit an HTTP request message requesting the sponsor search page from the registration computer 104.

Sponsor Interface Process

The registration server 104 receives the request for the sponsor interface web page from the sponsor computer 108 and the HTTP server program codes 632 (shown in FIG. 18) direct the microprocessor 602 to transmit the sponsor search web page to the sponsor computer 108.

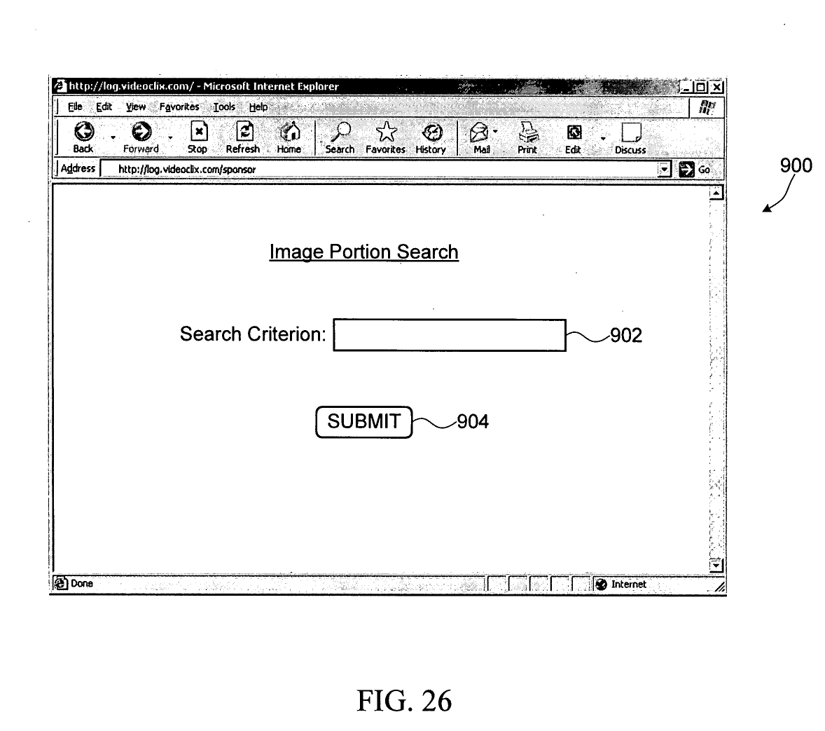

Referring to FIG. 26, a screenshot of the sponsor search page is shown generally at 900. The sponsor search page 900 includes a search criterion input box 902 and a submit button 904. When the sponsor enters one or more search terms into the input box 902 and then clicks on the submit button 904, the web browser program codes 880 direct the microprocessor 852 to transmit an HTTP sponsor search request including the search criterion entered in the input box 902 to the registration server 104.

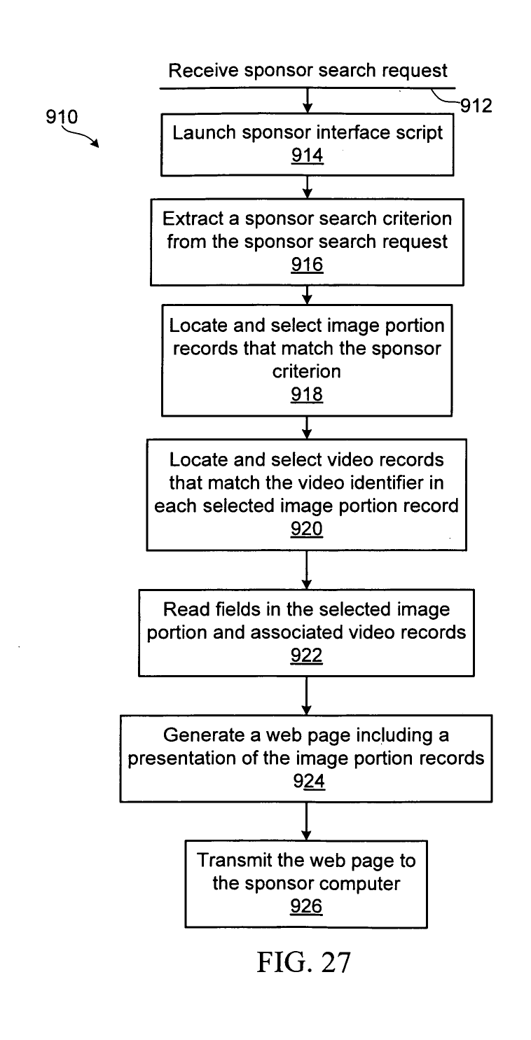

Referring to FIG. 27 a flowchart including blocks of code for directing the registration server processor circuit 600 to process the sponsor search request from the sponsor computer 108 is shown generally at 910.

The process begins at 912 when a sponsor search request is received from the sponsor computer 108.

Block 914 then directs the microprocessor 602 to launch the sponsor interface script 644. In one embodiment the sponsor interface script includes PHP codes for directing the microprocessor 602 to perform functions for processing the sponsor search request.

Block 916 then directs the microprocessor 602 to extract the search criterion from the sponsor search request.

The process then continues at block 918, which directs the microprocessor 602 to produce a database query to locate image portion records 800 that match the sponsor search criterion. In one embodiment the database management system 126 is the MySQL database management system, and the sponsor interface script 644 directs the microprocessor 602 to produce an SQL query. Block 918 further directs the microprocessor 602 to transmit the database query to the database processor circuit 600 (shown in FIG. 18).

The database processor circuit 600 receives the query at the interface 670 and the database management system program codes 682 direct the microprocessor 652 to locate image portion records that match the search criterion. For example, the search criterion may include a keyword, and image portion records 800 having a keyword in the keywords field 812 that matches the search criterion keyword are selected.

The process continues at block 920, which directs the registration server microprocessor 602 to read fields in the selected image portion records. In this embodiment, block 920 further directs the microprocessor 602 to produce a database query to locate video records 750 corresponding to the video identifier 804 in each selected image portion record.

The database processor circuit 600 receives the query and the database management system program codes 682 direct the microprocessor 652 to locate video records 750 that have a video identifier 752 that matches the video identifier associated with each of the selected image portion records.

Block 922 then directs the registration server microprocessor 602 to cause fields in the selected image portion records and the associated video records to be read.

The process then continues at block 924 which directs the microprocessor 602 to generate a web page including a presentation of selected records.

Block 926 then directs the microprocessor 602 to transmit the web page to the sponsor computer 108. The sponsor computer 108 receives and displays the web page in the browser window.

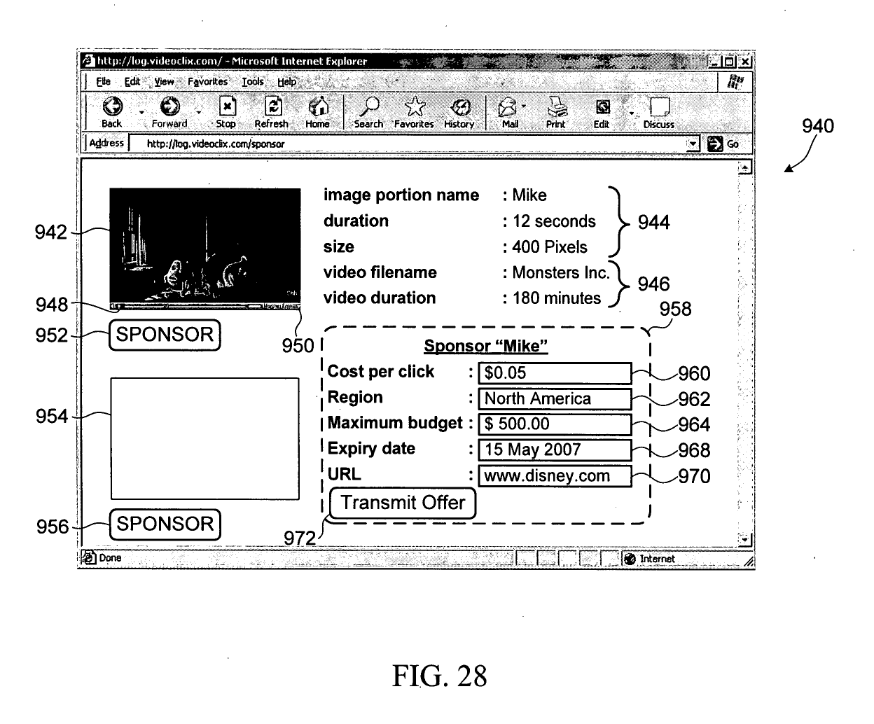

Referring to FIG. 28, an exemplary screenshot of the sponsor web page is shown generally at 940. The sponsor web page 940 includes an image portion preview window 942 for displaying the image portion preview file 570 shown in FIG. 17. The sponsor web page 940 also includes a plurality of image portion attributes 944, a plurality of video attributes 946, and a “sponsor” button 952.

The image portion preview window 942 includes a play button 948 for playing the preview video and a pair of chapter buttons for causing the preview video to jump to subsequent occurrences of the image portion 270 in the video content. When the sponsor clicks on the play button 948, the video reference track 574 causes the video content identified by the chapters track 572 to be streamed to the image portion preview window 942, to enable the sponsor to preview occurrences of the image portion 270 in the video content.

The image portion attributes 944 and the video attributes 946 display at least some of the fields in the image portion record 800 and the video record 750 respectively, to enable the sponsor to view other details of the image portion. In this embodiment

The web page 940 may further display second and subsequent image portion preview windows 954 and associated “sponsor” button 956 for other selected image portions.

Should the sponsor using the sponsor computer 108 wish to sponsor one of the image portions 270, the sponsor clicks on the sponsor button 952, which directs the sponsor computer microprocessor 852 to request a sponsor bid web page. In this embodiment, the sponsor bid web page is transmitted to the sponsor computer 108 by the registration server 104 as a popup web page, as shown in FIG. 28 generally at 958.

The sponsor bid web page 958 includes a plurality of input boxes including a “cost per click” box 960 for entering an offer of a payment to be made for each click of the indicia associated with the image portion 270, a geographic region box 962 for entering a geographic region restriction, a maximum budget box 964 for entering an restriction to the amount that the sponsor wishes to pay for clicks associated with the image portion 270, and an expiry data and time box 968 for entering an expiry of the offer.

The sponsor bid web page 958 further includes a send offer button 972 for causing the offer to be transmitted to the registration server 104. When the sponsor has entered offer details in the input boxes, and clicks on the send button 960, the processor circuit 850 transmits an offer message including the offer details to the registration server 104.

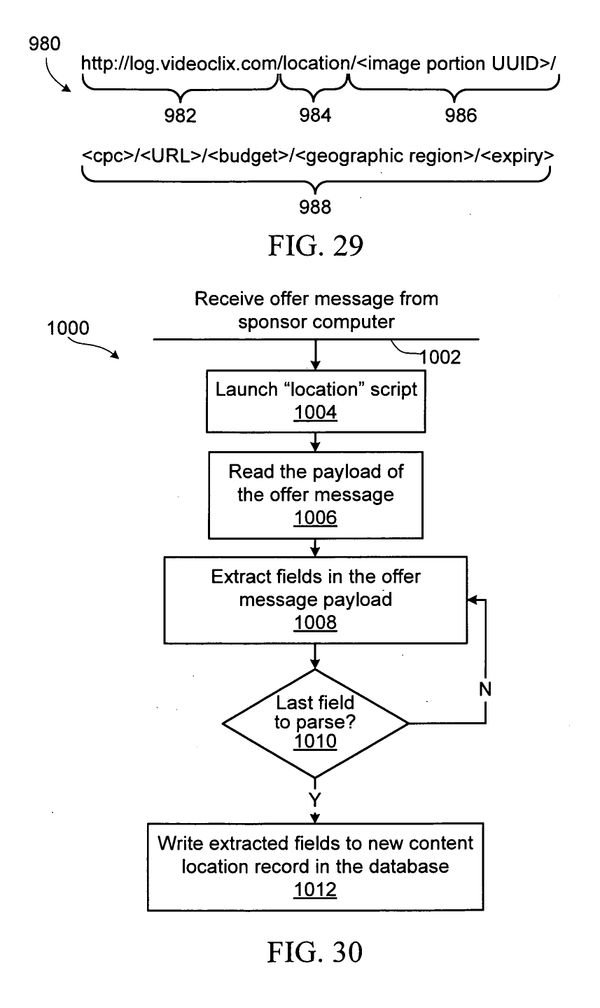

Referring to FIG. 29, an exemplary offer message is shown generally at 980. The offer message 980 may be formatted as a HTTP GET method and transmitted to the registration server 104 using TCP/IP.

The offer message 980 includes a first portion 982 identifying a location of the registration server and a second portion 984 identifying a script to be executed on the registration server 104. The offer message 980 also includes an image portion identifier identifier 986, which is associated with the image portion 270 shown in FIG. 28.

The offer message 980 also includes a payload portion, which includes a plurality of fields including information associated with the offer. In the example shown in FIG. 29, the payload 988 includes a cost per click field, a budget field, a geographic region field, and an expiry field, which generally correspond to the input boxes 960-970 shown in FIG. 28.

Content Location Record Creation & Population

Referring to FIG. 30 a flowchart including blocks of code for directing the registration server processor circuit 600 to process the offer message 980 is shown generally at 1000.

The process begins at 1002 when the offer message 980 is received from the sponsor computer 108.

Block 1004 directs the microprocessor 602 to launch the “location” script program codes 636 in the program memory 604 (shown in FIG. 18).

Block 1006 then directs the microprocessor 602 to read the image portion identifier 986 and the payload 988 of the offer message 980.

The process then continues at block 1008, which directs the microprocessor 602 to successively extract the image portion identifier 986, and the fields in the payload 988 of the offer message 980.

Block 1010 then directs the microprocessor 602 to determine whether the last field extracted was the last field in the offer message 980, in which case the process continues at block 1012.

If at block 1100 the last field parsed is not the last field in the offer message 980, then the process continues at block 1008 as described above.

Block 1102 then directs the microprocessor 602 to write the extracted fields to a new content location record in the database 124.

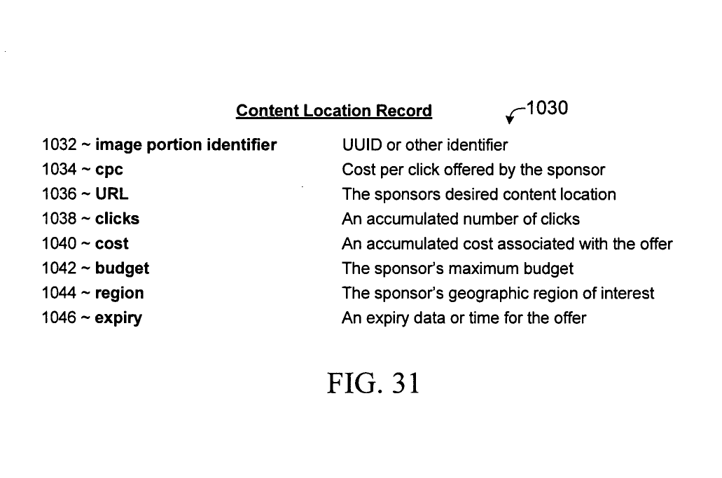

Referring to FIG. 31, an exemplary format of a content location record is shown generally at 1030. The content location record 1030 generally includes fields that correspond to fields in the offer message 980, including a image portion identifier 1032, which is used as the primary key association for the content location record to facilitate association with other records. The content location record 1030 further includes a cpc field 1034, a URL field 1036, a clicks field 1038 for storing an accumulated number of clicks, a cost field 1040 for storing an accumulated cost associated with the offer, a budget field 1042, a region field 1044, and an expiry field 1046.

Advantageously, a plurality of sponsors may offer to sponsor each image portion, and the sponsor may place one or more offer restrictions on the offer. Accordingly, each offer placed by a sponsor causes an associated content location record to be produced and stored in the database 124. Some offer restrictions, such as a geographic restriction may result in different sponsors being active for different regions, as will be described later herein.

Client Display Device

In one embodiment, the client display devices 110, 112,116 and 118 are implemented using the generic processor circuit 850 shown in FIG. 25.

In general, when a user of one of the client display devices 110, 112, 116 and 118 wishes to view video content, the user causes the web browser program codes to be launched to open a web browser window on the client display device. Links to video content may be viewed on a plurality of different web sites such as Google® Video or YouTube (www.youtube.com), for example. Such web sites provide hyperlinked images or filenames, for example, that when clicked on cause a HTTP request to be sent to a video server, such as the video server 106 shown in FIG. 1. The video server 106 responds by locating the video content stored on the video server or another location on the computer network 120, and transmits the video content to the client display device.

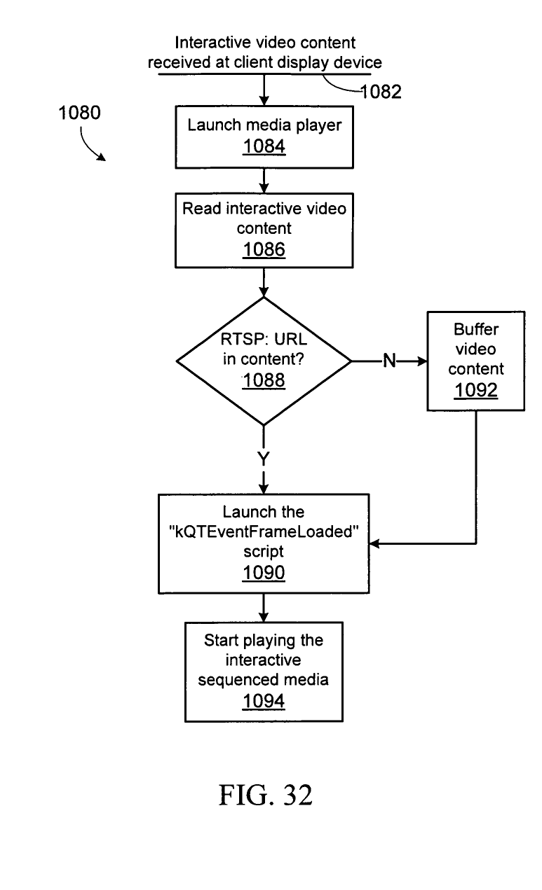

Referring to FIG. 32, process flowchart including blocks of code for directing the processor circuit 850 to play interactive video content received from the video server 106 is shown generally at 1080.

The process begins at 1082 when interactive video content (such as the QuickTime video file 500 shown in FIG. 14) is received at the interface 870 of the client display device processor circuit 850.

Block 1084 then directs the microprocessor 852 to launch the video player program codes 882 to cause a video player window (such as a QuickTime player window) to be displayed on a display 130, 132, 134, or 136 of the respective client display device 110, 112, 114, or 116.

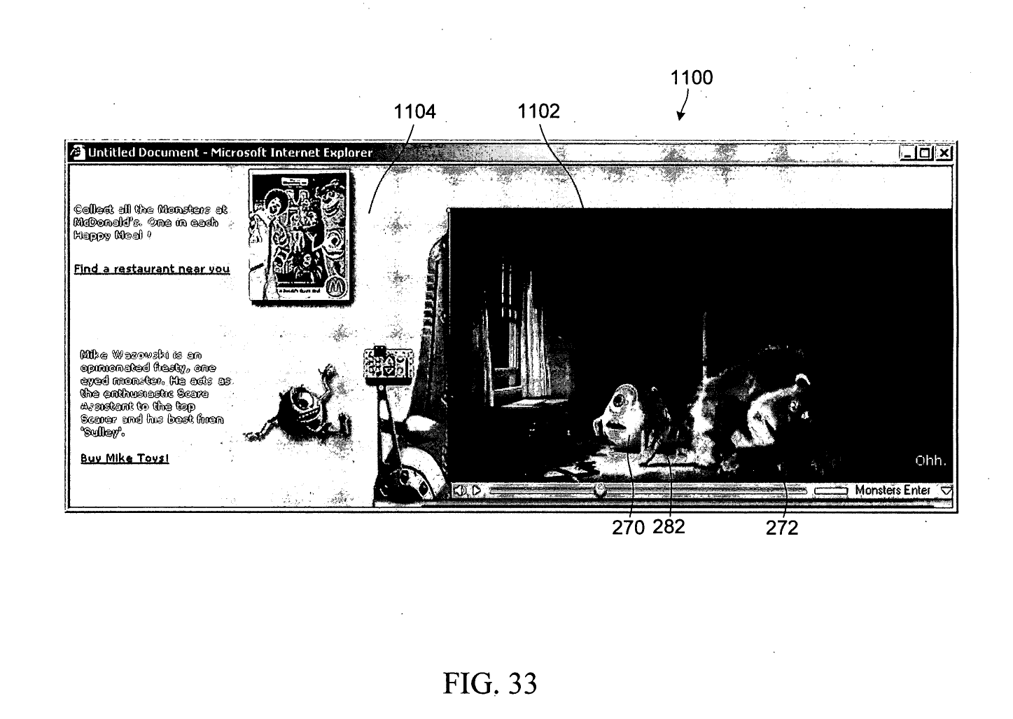

Referring to FIG. 33, a screenshot of an exemplary video player window displayed in a web browser window 1100 is shown generally at 1102. In this embodiment the video player window 1102 is a QuickTime embedded video player window configured to display video content within the web browser window 1100. The web browser window 1100 further includes a content display area 1104 for displaying non-video content.

Referring back to FIG. 32, block 1086 then directs the microprocessor 852 to begin reading the interactive video content in the video file 500. Block 1088 then directs the microprocessor 852 to determine whether the video content includes an RTSP, RTMP, or HTTP URL. In the case of RTSP or RTMP, the video content may be streamed to the video player window in near real time. The process then continues at block 1090 which directs the microprocessor 852 to launch the “kQTEventFrameLoaded” script. The “kQTEventFrameLoaded” script directs the microprocessor 852 to read data atoms for each of the defined indicia shapes that are included in the indicia track (e.g. the indicia shape 282 which is shown in broken outline in FIG. 33, since the shape is not generally visible). The “kQTEventFrameLoaded” script also directs the microprocessor 852 to read the indicia variables 370 associated with the indicia shape 282 and to initialize the indicia image 282 to be “displayed” at a location defined in the associated data atom. Block 1094 then directs the microprocessor 852 to begin playing the video content including the indicia image 282, which is not visible to the viewer of the video content, since the indicia track 506 is displayed behind the video track 522 or rendered so as to be transparent (i.e. with an alpha level of zero for an Adobe Flash file format), as described above in reference to FIG. 14. In the case of Flash playback, video update events will initiate redraws of the indicia image according to the playback position.

If at block 1088, the video content does not include a RTSP or RTMP URL, then the at least a portion of the video content is downloaded into the RAM 856 or the persistent memory 858, before blocks 1090 and 1094 direct the processor to launch the “kQTEventFrameLoaded” script and play the video content, as described above.

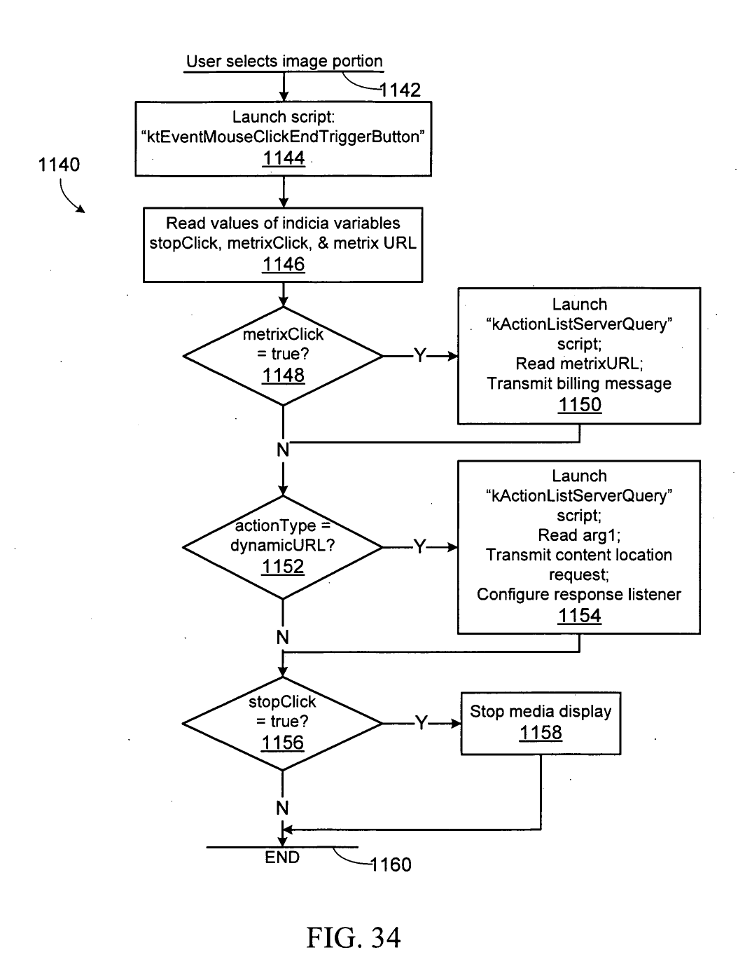

Referring to FIG. 34, a process flowchart including blocks of codes for directing the processor circuit 850 to produce a content location request is shown generally at 1140.

The process begins at 1142 when the user of the client display device selects an image portion (such as the image portion 270 shown in FIG. 33). In general selection of the image portion 270 occurs when the I/O interface 872 receives user input signals from the pointing device 876 in response to user actuation thereof. The operating system program codes 878 include a handler routine for processing the user input signals, and for producing interrupt event signals that are received by the video player. The video player in turn generates a “mouse click end trigger button” event message and sends the message to the data atom associated with the indicia image 282.

Block 1144 then directs the microprocessor 852 to launch the “ktEventMouseClickEndTriggerButton” script, which directs the microprocessor 852 to read the indicia variables 370 (shown in FIG. 8) that are associated with the indicia 282.

Block 1148 then directs the microprocessor 852 to determine whether the metrixClick variable is set to “yes”, in which case the process continues at block 1150.

Block 1150 directs the microprocessor 852 to launch the “kActionListServerQuery” script, which directs the microprocessor to read the metrixURL variable 356 and to format the billing message 357 as an HTTP GET message. Block 1150 also directs the microprocessor 852 to cause the interface 870 of the I/O 862 to transmit the billing message to the registration server 104.

The process then continues at block 1152. If at block 1148 the metrixClick variable is set to “no”, then the process also continues at block 1152.

Block 1152 directs the microprocessor 852 to determine whether the actionType variable 360 is set to “DynamicURL”, in which case the process continues at block 1154.

Block 1154 directs the microprocessor 852 to launch the “kActionListServerQuery” script (if not already launched at block 1150). The “kActionListServerQuery” script directs the microprocessor 852 to read the arg1 variable 362 and to format the content location request 363 as an HTTP GET message. Block 1154 also directs the microprocessor 852 to cause the interface 870 of the I/O 862 to transmit the content location request to the registration server 104. Block 1154 further directs the microprocessor 852 to launch an response listener routine that listens for a response to the content location request and directs the microprocessor 602 to generate a response event signal, when the response is received.

The process then continues at block 1156. If at block 1152 the actionType variable 360 is not set to “DynamicURL”, then the process continues at block 1156.

Block 1156 directs the microprocessor 252 to determine whether the stopClick variable 352 is set to “Yes”, in which case the process continues at block 1158, which directs the microprocessor 852 to cause playback of the video content to be stopped. The process then ends at 1160.

If at block 1156, the stopClick variable 352 is set to “No” then the process ends at 1160.

In this embodiment, separate the billing message 357 and the content location request 363 are separately transmitted to the registration server 104. However in other embodiments, a single message (not shown) may be transmitted to the registration server 104, to cause a charge to be generated to a sponsor account and a content location to be transmitted to the client display device.

Processing of Content Location Request and Billing Message

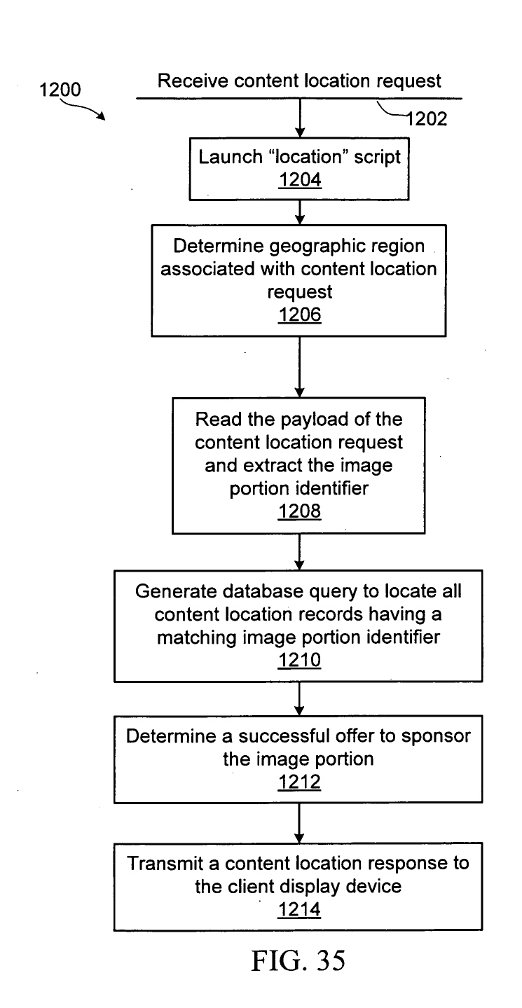

Referring to FIG. 35, a flowchart including blocks of code for directing the registration server processor circuit 600 to process the content location request is shown generally at 1200.

The process begins at 1202 when the content location request is received at the interface 620 of the processor circuit 600. In this embodiment the message is an HTTP GET message, which is transmitted on the network in accordance with the TCP/IP protocol.

Block 1204 directs the microprocessor 602 to launch the “location” script program codes 636 in the program memory 604 (shown in FIG. 18).

Block 1206 then directs the microprocessor 602 to read the internet protocol (IP) source address from the header of an IP packet including the request message payload and to attempt to determine a geographic region from which the content location request originated. Several software functions are generally available for determining a geographic region corresponding to a source IP address. For example, the publicly accessible NetGeo database operated by the Cooperative Association for Internet Data Analysis (CAIDA) may be queried using a PHP script function, to return geographic information to the registration server 104. In some embodiments it may be sufficient to only determine a country of origin, but geolocation software functions are now available that may be able to locate an IP address within a few city blocks. Block 1206 further directs the microprocessor 602 to store the geographic region in the RAM 606 for later use.

The process then continues at block 1208 which directs the microprocessor 602 to read the payload of the content location request message (i.e. the third portion 373 of the content location request 363 shown in FIG. 8). Block 1208 further directs the microprocessor 602 to extract the image portion identifier from the payload and to store the image portion identifier in RAM for later use.

Block 1210 then directs the microprocessor to generate a database query to locate all content location records (e.g. the content location record 1030 shown in FIG. 31) that have an image portion identifier in the field 1032 that matches the image portion identifier in the content request location. As described above, each image portion may have a plurality of content location records stored in the database 124, each record representing a different offer associated with the image portion.

The process then continues at block 1212, which directs the microprocessor 602 read certain fields in the content location record to determine a currently successful offer to sponsor the image portion (i.e. to provide a content location).

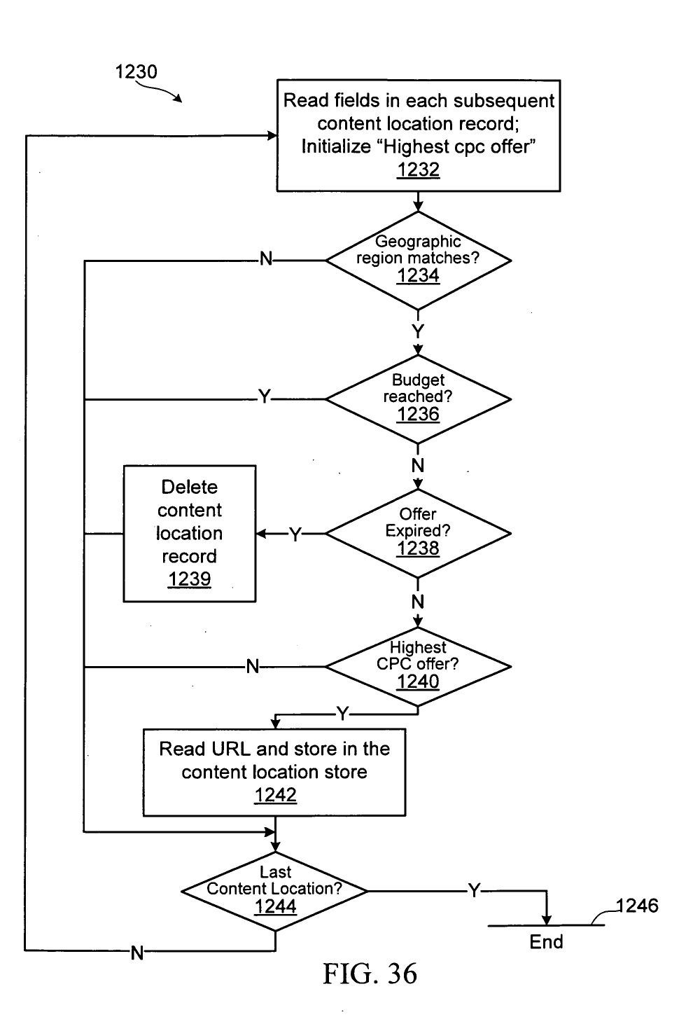

Referring to FIG. 36, a process flowchart including blocks of codes for directing the registration server processor circuit 600 to determine the currently successful offer is shown generally at 1230.

The process begins at block 1232, which directs the microprocessor 602 to read the region field 1044, the budget field 1042, the cost field 1040, the expiry field 1046, and the cpc field 1034, for each content location record that matches the image portion identifier in the content location request. Block 1232 also directs the microprocessor 602 to initialize a “highest cpc” offer value stored in the RAM 606 to zero.

Block 1234 directs the microprocessor 602 to determine whether the geographic region in the region field 1044 matches the geographic region determined at block 1206 in FIG. 35 and stored in the RAM 606. If at block 1234 the region matches, then the process continues at block 1236.

Block 1236 directs the microprocessor 602 to determine whether the accumulated cost in the cost field 1040 has reached the maximum budget in the budget field 1042, which involves adding the offered cpc in the cpc field 1034 to the accumulated cost in the cost field 1040 and comparing the sum to the maximum budget in the budget field 1042. If the maximum budget has not been reached, then the process continues at block 1238.

Block 1238 directs the microprocessor 602 to determine whether the expiry date in the expiry field 1046 has passed, which involves reading a current processor circuit system date and comparing the current date to the expiry date. If the expiry date has not passed then the process continues at block 1240.

Block 1240 directs the microprocessor 602 to determine whether the offered cpc in the cpc field 1034 is the highest cpc offer, by comparing the cpc offer in the current record to the highest cpc offer stored in the RAM 606. If the current cpc offer exceeds the highest cpc offer stored in the RAM 606, then the process continues at block 1242.

Block 1242 directs the microprocessor 602 to read the content location URL in the URL field 1036 associated with the current content location record and to store the URL in a content location store in the RAM 606.

The process then continues at block 1044 which directs the microprocessor 602 to determine whether the current content location record is the last matching content location record stored in the database 124. If the content location record is the last record, then the process ends at 1046.

If at block 1234 the region does not match, or at block 1236 the budget is reached, or at block 1240 the offer cpc is not the highest offer then the process continues at block 1244 as described above.

If at block 1238, the offer has expired, then the process continues at block 1239 which directs the microprocessor 602 execute a function to cause the database to delete the current content location record. The process then continues at block 1244 as described above.

Referring back to FIG. 35, the process 1200 then continues at block 1216, which directs the microprocessor 602 to read the URL content location store in the RAM 606, and to transmit a content location response to the client display device that originated the content location request.

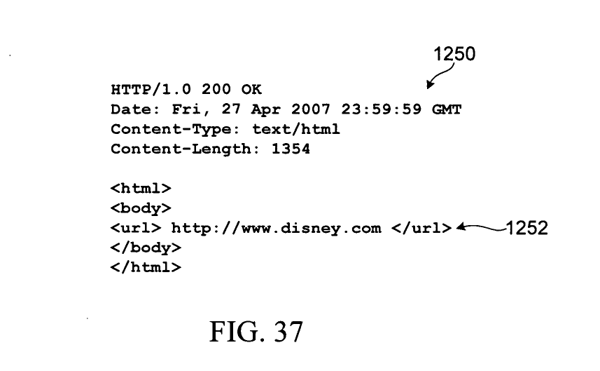

Referring to FIG. 37, an exemplary content location response is shown generally at 1250. The content location response 1250 may include the URL encoded as an Extensible Markup Language (XML) tag 1252 in an HTTP message.

In other embodiments the field 1252 may include a java script location, a “mailto:” location, or an identification of a software application to run on the client display device.

Response of Client Display Device to Content Location Response

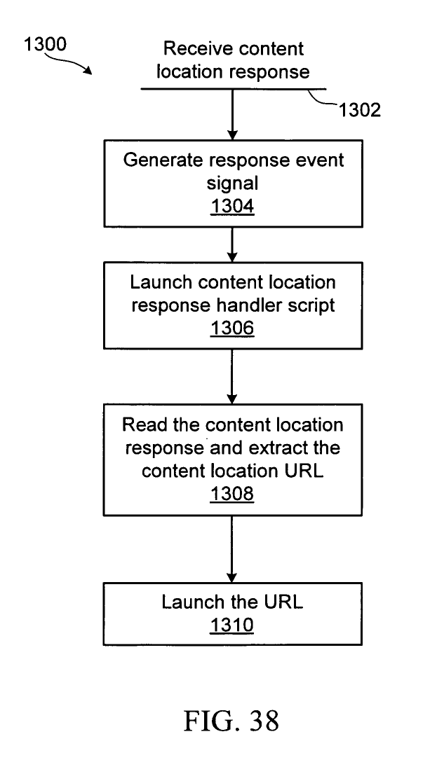

Referring to FIG. 38, a process flowchart for directs the microprocessor the client display device processor circuit 850 to handle the content location response is shown generally at 1300.

The process begins at 1302 when a content location response is received from the registration server 104. Block 1304 then directs the microprocessor 852 to generate the response event signal that indicates to the video player window 1102 shown in FIG. 33 that the response to the content location request has been received.

Block 1306 then directs the microprocessor 852 to launch the content location response handler script. Block 1308 then directs the microprocessor 852 to read the content location response 1250 (shown in FIG. 37) and to extract the content location 1252 from the XML data field in the response.

The process then continues at block 1310, which directs the microprocessor 852 to launch the URL. In this embodiment, the URL is launched by launching a new instance of the web browser program codes 880 with the URL as a target address. In other embodiments, the content location response may include a specific target application for launching the content location URL. For example, referring to FIG. 33, the content may be displayed in the content display area 1104, thus facilitating display of context relevant content alongside the video content displayed in the video player window 1102.

Advantageously, the embodiments described above facilitate provision of a content location URL to a viewer of interactive video content on a client display device in response to viewer selection of an image portion. The content location is selected from a validated set of content location records on the database 124, thus preventing the provision of a URL that is not active, not relevant, or for which the sponsor is no longer willing to pay a sponsorship fee. The system also facilitates geographic targeting of sponsorship of image portions, such that viewers of the interactive video content in different countries or even different cities receive relevant sponsored content. The system also provides for sponsors to restrict their sponsorship of an image portion to a specific timeframe, or total budget, thus providing more targeted sponsorships.

Interactive content publishers may enter into an agreement with the operator of the registration server to receive some portion of the proceeds generated by sponsorship of image portions in the interactive video content authored by them. Content publishes may be readily identified as being the publisher of an image portion by the content publisher identifier 754 associated with the video record 750 shown in FIG. 21.

While specific embodiments of the invention have been described and illustrated, such embodiments should be considered illustrative of the invention only and not as limiting the invention as construed in accordance with the accompanying claims.

What is claimed is:

1. A method for producing interactive video content on a content publisher computer, the method comprising:
associating indicia with at least one image portion in said video content, said indicia being operably configured to follow said at least one image portion as a display position of said image portion changes in said video content;
associating an image portion identifier with said indicia; and
associating link properties with said indicia, said link properties being operable to cause transmission of a content location request to a registration server in response to selection of said indicia by a viewer of the interactive video content, said content location request including said image portion identifier.

2. The method of claim 1 further comprising reading the video content from a video file.

3. The method of claim 1 further comprising generating said image portion identifier.

4. The method of claim 3 wherein generating said image portion identifier comprises generating a universally unique image portion identifier.

5. The method of claim 3 wherein the content publication computer is in communication with said registration server in a computer network, and further comprising transmitting an indicia registration request to said registration server to request registration of said indicia and said associated image portion identifier by said registration server.

6. The method of claim 1 wherein associating said image portion identifier with said indicia comprises:
transmitting an indicia registration request to said registration server to request registration of said indicia by said registration server; and
receiving said image portion identifier from said registration server in response to transmitting said indicia registration request.

7. The method of claim 4 wherein transmitting said indicia registration request comprises transmitting an image portion attribute indicator to said registration server, said image portion attribute indicator indicating at least one attribute of said at least one image portion.

8. The method of claim 7 wherein transmitting said image portion attribute indicator comprises transmitting at least one of:
a name associated with said at least one image portion;
a keyword associated with said at least one image portion;
a description associated with said at least one image portion;
information identifying occurrences of said at least one image portion in said video content;
a duration for which said at least one image portion is displayed during each said occurrence; and
a number of pixels occupied by said at least one image portion during each said occurrence.

9. The method of claim 1 wherein associating said indicia with said at least one image portion comprises:
displaying said video content in a display area of a video player displayed on the content publisher computer;
selecting an image portion of interest in response to user input received from a user of the content publisher computer thereby identifying a selected image portion; and
associating said indicia with said selected image portion.

10. The method of claim 1 wherein associating said indicia with said selected image portion comprises associating an indicia shape with said image portion.

11. The method of claim 10 further comprising producing a plurality of frames of video content identifying a position of said indicia shape on said display area in response to user input signals received from a user of the content publisher computer.

12. The method of claim 11 further comprising adding an indicia track to the video content including said plurality of frames identifying said position of said indicia shape, said associated link properties, and said content location request message.

13. The method of claim 1 further comprising writing said interactive video content to a video file.

14. The method of claim 13 further comprising causing said video file to be saved to a persistent storage location on a video server, said video server being in communication with said computer network.

15. The method of claim 14 wherein the content publication computer is in communication with said registration server in a computer network and further comprising transmitting an image portion preview video file to said registration server.

16. The method of claim 15 wherein transmitting said image portion preview video file comprises transmitting an image portion preview video file comprising:
an identifier identifying said persistent storage location; and
information identifying occurrences of said at least one image portion in the interactive video content in said video file.

17. The method of claim 13 wherein the content publication computer is in communication with said registration server in a computer network and further comprising transmitting a video registration request to said registration server to request registration of said interactive video content.

18. The method of claim 17 wherein transmitting said video registration request comprises transmitting a video attribute indicator to said registration server, said video attribute indicator indicating at least one attribute of said interactive video content.

19. The method of claim 18 wherein transmitting said video attribute indicator comprises transmitting at least one of:
an identifier identifying an originator of the interactive video content;
a video identifier associated with the video file;
a filename associated with the video file;
a duration of said video content;
a number of frames per second associated with said video content;
a video compression/decompression algorithm (codec) associated with the interactive video content in the video file;
an audio compression/decompression algorithm (codec) associated with audio content in the video file; and
a video category indicator associated with the video content.

20. An apparatus for producing interactive video content on a content publisher computer, the apparatus comprising a processor circuit operably configured to:
associate indicia with at least one image portion in said video content, said indicia being operably configured to follow said at least one image portion as a display position of said image portion changes in said video content;
associate an image portion identifier with said indicia; and
associate link properties with said indicia, said link properties being operable to cause transmission of a content location request to a registration server in response to selection of said indicia by a viewer of the interactive video content, said content location request including said image portion identifier.

21. The apparatus of claim 20 wherein said processor circuit is operably configured to read the video content from a video file.

22. The apparatus of claim 20 wherein said processor circuit is operably configured to generate said image portion identifier.

23. The apparatus of claim 22 wherein said processor circuit is operably configured to generate a universally unique image portion identifier.

24. The apparatus of claim 22 wherein the content publication computer is in communication with said registration server in a computer network, and wherein said processor circuit is operably configured to transmit an indicia registration request to said registration server to request registration of said indicia and said associated image portion identifier by said registration server.

25. The apparatus of claim 20 wherein said processor circuit is operably configured to associate said image portion identifier with said indicia by:
transmitting an indicia registration request to said registration server to request registration of said indicia by said registration server; and
receiving said image portion identifier from said registration server in response to transmitting said indicia registration request.

26. The apparatus of claim 23 wherein said processor circuit is operably configured to transmitting said indicia registration request by transmitting an image portion attribute indicator to said registration server, said image portion attribute indicator indicating at least one attribute of said at least one image portion.

27. The apparatus of claim 26 wherein said processor circuit is operably configured to transmitting said image portion attribute indicator by transmitting at least one of:
a name associated with said at least one image portion;
a keyword associated with said at least one image portion;
a description associated with said at least one image portion;
information identifying occurrences of said at least one image portion in said video content;
a duration for which said at least one image portion is displayed during each said occurrence; and
a number of pixels occupied by said at least one image portion during each said occurrence.

28. The apparatus of claim 20 wherein said processor circuit is operably configured to associate said indicia with said at least one image portion by:
displaying said video content in a display area of a video player displayed on the content publisher computer;
selecting an image portion of interest in response to user input received from a user of the content publisher computer thereby identifying a selected image portion; and
associating said indicia with said selected image portion.

29. The apparatus of claim 20 wherein said processor circuit is operably configured to associate said indicia with said selected image portion by associating an indicia shape with said image portion.

30. The apparatus of claim 29 wherein said processor circuit is operably configured to produce a plurality of frames of video content identifying a position of said indicia shape on said display area in response to user input signals received from a user of the content publisher computer.

31. The apparatus of claim 30 wherein said processor circuit is operably configured to add an indicia track to the video content including said plurality of frames identifying said position of said indicia shape, said associated link properties, and said content location request message.

32. The apparatus of claim 20 wherein said processor circuit is operably configured to write said interactive video content to a video file.

33. The apparatus of claim 32 wherein said processor circuit is operably configured to cause said video file to be saved to a persistent storage location on a video server, said video server being in communication with said computer network.

34. The apparatus of claim 33 wherein the content publication computer is in communication with said registration server in a computer network and wherein said processor circuit is operably configured to transmit an image portion preview video file to said registration server.

35. The apparatus of claim 34 wherein said processor circuit is operably configured to transmit an image portion preview video file comprising:
an identifier identifying said persistent storage location; and
information identifying occurrences of said at least one image portion in the interactive video content in said video file.

36. The apparatus of claim 32 wherein the content publication computer is in communication with said registration server in a computer network and wherein said processor circuit is operably configured to transmit a video registration request to said registration server to request registration of said interactive video content.

37. The apparatus of claim 36 wherein said processor circuit is operably configured to transmit said video registration request by transmitting a video attribute indicator to said registration server, said video attribute indicator indicating at least one attribute of said interactive video content.

38. The apparatus of claim 37 wherein said processor circuit is operably configured to transmitting said video attribute indicator by transmitting at least one of:
an identifier identifying an originator of the interactive video content;
a video identifier associated with the video file;
a filename associated with the video file;
a duration of said video content;
a number of frames per second associated with said video content;
a video compression/decompression algorithm (codec) associated with the interactive video content in the video file;
an audio compression/decompression algorithm (codec) associated with audio content in the video file; and
a video category indicator associated with the video content.

39. A computer readable medium encoded with codes for directing a processor circuit to produce interactive video content on a content publisher computer, the codes directing the processor circuit to:
associate indicia with at least one image portion in said video content, said indicia being operably configured to follow said at least one image portion as a display position of said image portion changes in said video content;
associate an image portion identifier with said indicia; and
associate link properties with said indicia, said link properties being operable to cause transmission of a content location request to a registration server in response to selection of said indicia by a viewer of the interactive video content, said content location request including said image portion identifier.

40. A computer readable signal encoded with codes for directing a processor circuit to produce interactive video content on a content publisher computer, the codes directing the processor circuit to:
associate indicia with at least one image portion in said video content, said indicia being operably configured to follow said at least one image portion as a display position of said image portion changes in said video content;
associate an image portion identifier with said indicia; and
associate link properties with said indicia, said link properties being operable to cause transmission of a content location request to a registration server in response to selection of said indicia by a viewer of the interactive video content, said content location request including said image portion identifier.

41. A method for registering indicia associated with an image portion of interest on a registration server in communication with a computer network, the image portion occurring in interactive video content produced on a content publisher computer, the method comprising:
receiving an indicia registration request from the content publisher computer;
causing an image portion record to be produced in response to receiving said indicia registration request;
associating said image portion record with an image portion identifier; and
causing said image portion record to be stored in a database.

42. The method of claim 41 wherein receiving said indicia registration request comprises receiving said image portion identifier from the content publisher computer.

43. The method of claim 41 further comprising generating said image portion identifier and transmitting said image portion identifier to the content publisher computer in response to receiving said indicia registration request.

44. The method of claim 43 wherein generating said image portion identifier comprises generating a universally unique image portion identifier.

45. The method of claim 41 wherein receiving said indicia registration request comprises receiving an image portion attribute indicator from the content publisher computer and wherein causing said image portion record to be produced comprises causing said image portion attribute indicator to be saved in an image portion attribute indicator field in said image portion record.

46. The method of claim 45 wherein receiving said image portion attribute indicator comprises receiving at least one of:
information identifying occurrences of said image portion in said video content;
a duration for which said image portion is displayed during each said occurrence; and
a number of pixels occupied by said image portion during each said occurrence.

47. The method of claim 41 wherein associating said image portion record with said image portion identifier comprises causing said image portion identifier to be stored in an image portion identifier field in said image portion record.

48. The method of claim 41 further comprising:
receiving an image portion preview video file from the content publisher computer; and
wherein causing said image portion record to be produced comprises causing said image portion preview video file to be saved in an image portion preview field in said image portion record.

49. The method of claim 48 wherein receiving said image portion preview video file comprises receiving an image portion preview video file comprising:
an identifier identifying a location of said interactive video content on the computer network; and
information identifying occurrences of said image portion in said interactive video content.

50. The method of claim 41 further comprising:
receiving a video registration request from the content publisher computer;
causing a video record to be produced in response to receiving said video registration request;
associating said video record with a video identifier; and
causing said video record to be stored in said database.

51. The method of claim 50 wherein receiving said video registration request comprises receiving a video attribute indicator from the content publisher computer, said video attribute indicator indicating at least one attribute of said interactive video content, and further comprising causing said video attribute indicator to be stored in a video attribute indicator field in said video record.

52. The method of claim 51 wherein receiving said video attribute indicator comprises receiving one of:
an identifier identifying an originator of the interactive video content;
a filename associated with the video file;
a duration of said interactive video content;
a number of frames per second associated with said interactive video content;
a video compression/decompression algorithm (codec) associated with the interactive video content in the video file;
an audio compression/decompression algorithm (codec) associated with audio content in the video file; and
a video category indicator associated with the interactive video content.

53. The method of claim 50 wherein associating said video record with said video identifier comprises causing said video identifier to be saved in a video identifier field in said video record.

54. The method of claim 50 further comprising associating said image portion record with said video record in said database.

55. The method of claim 54 wherein associating said image portion record with said video record comprises causing said video identifier to be stored in a video identifier field in said image portion record.

56. An apparatus for registering indicia associated with an image portion of interest on a registration server in communication with a computer network, the image portion occurring in interactive video content produced on a content publisher computer, the apparatus comprising a processor circuit operably configured to:
receive an indicia registration request from the content publisher computer;
cause an image portion record to be produced in response to receiving said indicia registration request;
associate said image portion record with an image portion identifier; and
cause said image portion record to be stored in a database.

57. The apparatus of claim 56 wherein said processor circuit is operably configured to receive said image portion identifier from the content publisher computer.

58. The apparatus of claim 56 wherein said processor circuit is operably configured to generate said image portion identifier and to transmit said image portion identifier to the content publisher computer in response to receiving said indicia registration request.

59. The apparatus of claim 58 wherein said processor circuit is operably configured to generate a universally unique image portion identifier.

60. The apparatus of claim 56 wherein said processor circuit is operably configured to receive said indicia registration request by receiving an image portion attribute indicator from the content publisher computer and said processor circuit is operably configured to cause said image portion record to be produced by causing said image portion attribute indicator to be saved in an image portion attribute indicator field in said image portion record.

61. The apparatus of claim 60 wherein said processor circuit is operably configured to receive said image portion attribute indicator by receiving at least one of:
information identifying occurrences of said image portion in said video content;
a duration for which said image portion is displayed during each said occurrence; and
a number of pixels occupied by said image portion during each said occurrence.

62. The apparatus of claim 56 wherein said processor circuit is operably configured to associate said image portion record with said image portion identifier by causing said image portion identifier to be stored in an image portion identifier field in said image portion record.

63. The apparatus of claim 56 wherein said processor circuit is operably configured to:
receive an image portion preview video file from the content publisher computer; and
cause said image portion preview video file to be saved in an image portion preview field in said image portion record.

64. The apparatus of claim 63 wherein said processor circuit is operably configured to receive an image portion preview video file comprising:
an identifier identifying a location of said interactive video content on the computer network; and
information identifying occurrences of said image portion in said interactive video content.

65. The apparatus of claim 56 wherein said processor circuit is operably configured to:
receive a video registration request from the content publisher computer;
cause a video record to be produced in response to receiving said video registration request;
associate said video record with a video identifier; and
cause said video record to be stored in said database.

66. The apparatus of claim 65 wherein said processor circuit is operably configured to receive said video registration request by receiving a video attribute indicator from the content publisher computer, said video attribute indicator indicating at least one attribute of said interactive video content, and wherein said processor circuit is operably 10 configured to cause said video attribute indicator to be stored in a video attribute indicator field in said video record.

67. The apparatus of claim 66 wherein said processor circuit is operably configured to receive said video attribute indicator by receiving one of:
an identifier identifying an originator of the interactive video content;
a filename associated with the video file;
a duration of said interactive video content;
a number of frames per second associated with said interactive video content;
a video compression/decompression algorithm (codec) associated with the interactive video content in the video file;
an audio compression/decompression algorithm (codec) associated with audio content in the video file; and
a video category indicator associated with the interactive video content.

68. The apparatus of claim 65 wherein said processor circuit is operably configured to associate said video record with said video identifier by causing said video identifier to be saved in a video identifier field in said video record.

69. The apparatus of claim 65 wherein said processor circuit is operably configured to associate said image portion record with said video record in said database.

70. The apparatus of claim 69 wherein said processor circuit is operably configured to associate said image portion record with said video record by causing said video identifier to be stored in a video identifier field in said image portion record.

71. A computer readable medium encoded with codes for directing a processor circuit to register indicia associated with an image portion of interest on a registration server in communication with a computer network, the image portion occurring in interactive video content produced on a content publisher computer, the codes directing the processor circuit to:
receive an indicia registration request from the content publisher computer;
cause an image portion record to be produced in response to receiving said indicia registration request;
associate said image portion record with an image portion identifier; and
cause said image portion record to be stored in a database.

72. A computer readable signal encoded with codes for directing a processor circuit to register indicia associated with an image portion of interest on a registration server in communication with a computer network, the image portion occurring in interactive video content produced on a content publisher computer, the codes directing the processor circuit to:
receive an indicia registration request from the content publisher computer;
cause an image portion record to be produced in response to receiving said indicia registration request;
associate said image portion record with an image portion identifier; and
cause said image portion record to be stored in a database.

73. A method for associating a sponsor content location with an image portion of interest occurring in interactive video content, the image portion having been registered on a registration server in communication with a computer network, the method comprising:
receiving a offer message from a sponsor computer at the registration server, said offer message including an image portion identifier identifying the image portion and a sponsor content location identifier;
causing an image portion record associated with said image portion identifier to be located in a database in communication with the registration server; and
associating said sponsor content location identifier with said image portion record.

74. The method of claim 73 wherein associating said sponsor content location identifier with said image portion record comprises storing said sponsor content location identifier in a sponsor content location field in said image, portion record.

75. The method of claim 73 wherein associating said sponsor content location identifier with said image portion record comprises:
causing a content location record to be produced in response to receiving said offer message;
causing said sponsor content location provided in said offer message to be stored in a content location field in said content location record;
associating said content location record with said image portion record; and
causing said content location record to be stored in said database.

76. The method of claim 75 wherein associating said content location record with said image portion record comprises storing said image portion identifier in an image portion identifier field in said content location record.

77. The method of claim 75 wherein receiving said offer message comprises receiving at least one offer restriction, said at least one offer restriction comprising at least one of:
a cost-per-click offer;
a budget associated with said cost-per-click offer;
a geographic indicator indicating a targeted geographic region;
a video category;
a start time associated with said cost-per-click offer;
an end time associated with said cost-per-click offer; and and wherein causing said content location record to be produced comprises storing said at least one offer restriction in an offer restriction field in said content location record.

78. The method of claim 73 further comprising:
causing a plurality of image portion records to be located in said database;
transmitting a web page to the sponsor computer, said web page including an identifier identifying each of said image portions associated with respective image portion records in said plurality of image portion records; and
transmitting an image portion preview video file to the sponsor computer for each respective image portion.

79. The method of claim 78 wherein transmitting said image portion preview video file comprises transmitting an image portion preview video file comprising:
an identifier identifying a location of the interactive video content on the computer network; and
information identifying occurrences of said image portion in the interactive video content.

80. An apparatus for associating a sponsor content location with an image portion of interest occurring in interactive video content, the image portion having been registered on a registration server in communication with a computer network, the apparatus comprising a processor circuit operably configured to:
receive a offer message from a sponsor computer at the registration server, said offer message including an image portion identifier identifying the image portion and a sponsor content location identifier;
cause an image portion record associated with said image portion identifier to be located in a database in communication with the registration server; and
associate said sponsor content location identifier with said image portion record.

81. The apparatus of claim 80 wherein said processor circuit is operably configured to associate said sponsor content location identifier with said image portion record by storing said sponsor content location identifier in a sponsor content location field in said image portion record.

82. The apparatus of claim 80 wherein said processor circuit is operably configured to associate said sponsor content location identifier with said image portion record by:
causing a content location record to be produced in response to receiving said offer message;
causing said sponsor content location provided in said offer message to be stored in a content location field in said content location record;
associating said content location record with said image portion record; and
causing said content location record to be stored in said database.

83. The apparatus of claim 82 wherein said processor circuit is operably configured to associate said content location record with said image portion record by storing said image portion identifier in an image portion identifier field in said content location record.

84. The apparatus of claim 82 wherein said processor circuit is operably configured to receive at least one offer restriction, said at least one offer restriction comprising at least one of:
a cost-per-click offer;
a budget associated with said cost-per-click offer;
a geographic indicator indicating a targeted geographic region;
a video category;
a start time associated with said cost-per-click offer;
an end time associated with said cost-per-click offer; and
and wherein said processor circuit is operably configured to cause said content location record to be produced by storing said at least one offer restriction in an offer restriction field in said content location record.

85. The apparatus of claim 80 wherein said processor circuit is operably configured to:
cause a plurality of image portion records to be located in said database;
transmit a web page to the sponsor computer, said web page including an identifier identifying each of said image portions associated with respective image portion records in said plurality of image portion records; and
transmit an image portion preview video file to the sponsor computer for each respective image portion.

86. The apparatus of claim 85 wherein said processor circuit is operably configured to transmit an image portion preview video file comprising:
an identifier identifying a location of the interactive video content on the computer network; and
information identifying occurrences of said image portion in the interactive video content.

87. A computer readable medium encoded with codes for directing a processor circuit associate a sponsor content location with an image portion of interest occurring in interactive video content, the image portion having been registered on a registration server in communication with a computer network, the codes directing the processor circuit to:
receive a offer message from a sponsor computer at the registration server, said offer message including an image portion identifier identifying the image portion and a sponsor content location identifier;
cause an image portion record associated with said image portion identifier to be located in a database in communication with the registration server; and
associate said sponsor content location identifier with said image portion record.

88. A computer readable signal encoded with codes for directing a processor circuit associate a sponsor content location with an image portion of interest occurring in interactive video content, the image portion having been registered on a registration server in communication with a computer network, the codes directing the processor circuit to:
receive a offer message from a sponsor computer at the registration server, said offer message including an image portion identifier identifying the image portion and a sponsor content location identifier;
cause an image portion record associated with said image portion identifier to be located in a database in communication with the registration server; and
associate said sponsor content location identifier with said image portion record.

89. A method for providing a content location to a client display device in communication with a registration server in a computer network, the method comprising:
receiving a content location request message from the client display device at the registration server, said content location request message including an image portion identifier identifying a image portion displayed in interactive video content on the client display device;
determining a current content location associated with said image portion identifier;
producing a content location message including a content location identifier identifying said current content location; and
transmitting said content location message to said client display device.

90. The method of claim 89 wherein determining said current content location comprises:
causing a plurality of content location records associated with said image portion identifier to be located in a database, each content location record representing an offer from a sponsor computer to sponsor said image portion;
determining which one of said plurality of content location records represents a successful offer; and
reading a content location identifier from a content location identifier field in said one of said plurality of content location records representing said successful offer.

91. The method of claim 90 further comprising determining a geographic region associated with said content location request message and wherein determining which one of said plurality of content location records represents said successful offer comprises determining which of said content location records includes a geographic indicator that matches said geographic region associated with said content location request message, said geographic indicator being stored in a geographic indicator field in said content location record.

92. The method of claim 90 wherein determining which one of said plurality of content location records represents said successful offer comprises determining which of said content location records meets a criterion.

93. The method of claim 92 wherein determining which of said content location records meets said criterion, comprises determining, for each content location record, whether at least one of:
a budget value stored in a budget value field in the content location record has not yet been reached;
a video category indicator stored in a video category indicator field in said content location record matches a video category indicator associated with the interactive video content in which said image portion occurs;
a start time stored in a start time field in said content location record has passed; and
an end time stored in an end time field in said content location record has not yet passed.

94. The method of claim 92 wherein determining which one of said plurality of content location records represents said successful offer comprises determining which of said content location records that meet said criterion has a greatest cost-per-click (CPC) offer value stored in a cost-per-click-field in said content location record.

95. An apparatus for providing a content location to a client display device in communication with a registration server in a computer network, the apparatus comprising a processor circuit operably configured to:
receive a content location request message from the client display device at the registration server, said content location request message including an image portion identifier identifying a image portion displayed in interactive video content on the client display device;
determine a current content location associated with said image portion identifier;
produce a content location message including a content location identifier identifying said current content location; and
transmit said content location message to said client display device.

96. The apparatus of claim 95 wherein said processor circuit is operably configured to determine said current content location by:
causing a plurality of content location records associated with said image portion identifier to be located in a database, each content location record representing an offer from a sponsor computer to sponsor said image portion;
determining which one of said plurality of content location records represents a successful offer; and
reading a content location identifier from a content location identifier field in said one of said plurality of content location records representing said successful offer.

97. The apparatus of claim 96 wherein said processor circuit is operably configured to determine a geographic region associated with said content location request message and wherein said processor circuit is operably configured to determine which one of said plurality of content location records represents said successful offer by determining which of said content location records includes a geographic indicator that matches said geographic region associated with said content location request message, said geographic indicator being stored in a geographic indicator field in said content location record.

98. The apparatus of claim 96 wherein said processor circuit is operably configured to determine which one of said plurality of content location records represents said successful offer by determining which of said content location records meets a criterion.

99. The apparatus of claim 98 wherein said processor circuit is operably configured to determine which of said content location records meets said criterion by determining, for each content location record, whether at least one of:
a budget value stored in a budget value field in the content location record has not yet been reached;
a video category indicator stored in a video category indicator field in said content location record matches a video category indicator associated with the interactive video content in which said image portion occurs;
a start time stored in a start time field in said content location record has passed; and
an end time stored in an end time field in said content location record has not yet passed.

100. The apparatus of claim 98 wherein said processor circuit is operably configured to determine which one of said plurality of content location records represents said successful offer by determining which of said content location records that meet said criterion has a greatest cost-per-click (CPC) offer value stored in a cost-per-click-field in said content location record.

101. A computer readable medium encoded with codes for directing a processor circuit to provide a content location to a client display device in communication with a registration server in a computer network, the codes directing the processor circuit to:
receive a content location request message from the client display device at the registration server, said content location request message including an image portion identifier identifying a image portion displayed in interactive video content on the client display device;
determine a current content location associated with said image portion identifier;
produce a content location message including a content location identifier identifying said current content location; and
transmit said content location message to said client display device.

102. A computer readable signal encoded with codes for directing a processor circuit to provide a content location to a client display device in communication with a registration server in a computer network, the codes directing the processor circuit to:
receive a content location request message from the client display device at the registration server, said content location request message including an image portion identifier identifying a image portion displayed in interactive video content on the client display device;
determine a current content location associated with said image portion identifier;
produce a content location message including a content location identifier identifying said current content location; and
transmit said content location message to said client display device.

103. A method for displaying interactive video content on a client display device, the client display device being in communication with a registration server in a computer network, the method comprising:
causing the interactive video to be displayed on the client display device, the interactive video including at least one image portion having an associated indicia, said indicia being operably configured to follow said image portion as a display position of said image portion changes in said video content; and
transmitting a content location request message to the registration server in response to a user of the client display device selecting said indicia, said content location request message including an image portion identifier identifying said image portion.

104. The method of claim 103 further comprising:
receiving a content location message from the registration server, said content location message including a content location identifier identifying a current content location associated with said image portion; and
causing content associated with said content location identifier to be displayed on the client display device.

105. The method of claim 94 wherein causing said content to be displayed comprises causing one of:
causing content associated with said content location identifier to be displayed in an internet browser window on the client display device;
causing content associated with said content location identifier to be displayed in a portion of a video viewer application window on the client display device; and
causing a link to said content location to be displayed in a said video viewer application window on the client display device.

106. An apparatus for displaying interactive video content on a client display device, the client display device being in communication with a registration server in a computer network, the apparatus comprising a processor circuit operably configured to:
cause the interactive video to be displayed on the client display device, the interactive video including at least one image portion having an associated indicia, said indicia being operably configured to follow said image portion as a display position of said image portion changes in said video content; and
transmit a content location request message to the registration server in response to a user of the client display device selecting said indicia, said content location request message including an image portion identifier identifying said image portion.

107. The apparatus of claim 106 wherein said processor circuit is operably configured to:
receive a content location message from the registration server, said content location message including a content location identifier identifying a current content location associated with said image portion; and
cause content associated with said content location identifier to be displayed on the client display device.

108. The apparatus of claim 107 wherein said processor circuit is operably configured to cause one of:
cause content associated with said content location identifier to be displayed in an internet browser window on the client display device;
cause content associated with said content location identifier to be displayed in a portion of a video viewer application window on the client display device; and
cause a link to said content location to be displayed in a said video viewer application window on the client display device.

109. A computer readable medium encoded with codes for directing a processor circuit to display interactive video content on a client display device, the client display device being in communication with a registration server in a computer network, the codes directing the processor circuit to:
cause the interactive video to be displayed on the client display device, the interactive video including at least one image portion having an associated indicia, said indicia being operably configured to follow said image portion as a display position of said image portion changes in said video content; and
transmit a content location request message to the registration server in response to a user of the client display device selecting said indicia, said content location request message including an image portion identifier identifying said image portion.

110. A computer readable signal encoded with codes for directing a processor circuit to display interactive video content on a client display device, the client display device being in communication with a registration server in a computer network, the codes directing the processor circuit to:
cause the interactive video to be displayed on the client display device, the interactive video including at least one image portion having an associated indicia, said indicia being operably configured to follow said image portion as a display position of said image portion changes in said video content; and
transmit a content location request message to the registration server in response to a user of the client display device selecting said indicia, said content location request message including an image portion identifier identifying said image portion.
